(19) United States
(12) Patent Application Publication
(10) Pub. No.: US 2007/0284053 A1
(43) Pub. Date: Dec. 13, 2007

(54) Assembly to lock a storm curtain adjacent to an opening in a building

(76) Inventors: Willis J. Mullet, Gulf Breeze, FL (US); Richard S. Hand, Pace, FL (US); Darrin W. Brunk, Pensacola, FL (US); Derek S. Paquette, Daphne, AL (US); Jason L. Mamaloukas, Milton, FL (US); Richard Bardin, Milton, FL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/799,357

(22) Filed: May 1, 2007

Related U.S. Application Data
(60) Provisional application No. 60/799,902, filed on May 12, 2006.
(60) Provisional application No. 60/816,830, filed on Jun. 27, 2006.

(51) Int. Cl. E05F 15/20

(52) U.S. Cl. 160/31; 160/239; 160/291; 160/311; 160/9

(57) ABSTRACT

An assembly for covering a building opening that provides a shaft positioned at one end of the building opening, a curtain carried by the shaft, and a locking mechanism at the opposed end of the building opening from the shaft that selectively holds the curtain in a locked position to cover the building opening. The assembly also includes an input for selectively rotating the shaft, and a linking assembly adapted to transfer the input to the shaft to selectively rotate the shaft, wherein the linking assembly includes a failsafe portion designed to fail upon a predetermined impact force on the curtain. An operator is also provided to allow controllable movement of the curtain between the various positions.

### CROSS-REFERENCE TO RELATED APPLICATIONS

This application claims the benefit of U.S. Provisional Application No. 60/799,902, filed May 12, 2006, and U.S. Provisional Application No. 60/816,830, filed Jun. 27, 2006, both of which are incorporated herein by reference.

### TECHNICAL FIELD

This invention relates to a storm curtain system which selectively obstructs an opening in a structure, such as a window, door or the like. The storm curtain system selectively prevents solar heat gain and protects the opening from intrusion due to high winds or windborne debris.

### BACKGROUND ART

In geographic areas which are prone to having high wind events, such as hurricanes and the like, the need exists for the protection of openings, such as windows and doors, in buildings. Otherwise, if the high winds or windborne debris breaches the integrity of the structure by destroying a window or door, severe damage to the structure can be expected.

In its most simple form, one type of known protection device which can be utilized is a sheet of plywood which can be attached to the structure so as to cover the openings thereof. However, this boarding up procedure is not only time consuming, when time is usually of the essence, but also can disfigure the exterior of the structure upon frequent installation and removal. In addition, plywood has a limited life, particularly after becoming wet. Finally, storing and maintaining an inventory of plywood sheets can be problematic.

As a result, a number of temporarily installable or permanently installed devices have been developed to be used as alternatives to plywood. For example, metallic shutters consisting of a plurality of hinged slats can be provided adjacent to a window and can be rolled up by a hand crank or a motor when not in use. However, these devices are not only costly, but also they do not provide the necessary wind or water resistant seal, irrespective of whether they are mounted on the windward or leeward side of the building.

More recently, fabric-based systems have been developed which are much less costly than the metallic shutters or other devices, and which can provide a seal for the openings in the structure. In their simplest form, these systems include a sheet of fabric which is strong enough to withstand high winds and the forces of wind-borne debris without rupturing. These fabric sheets may be sealed on all four edges, thus providing a seal for the structure even if the glass of a window, for example, has been broken, or a door blown open.

In such systems, the fabric is often times rolled up and stored in an upper housing and is payed out from the roll as the fabric curtain is pulled down between two side rails. Such systems typically include a single chamber which houses the roll and motor components, such as a tube motor. Because this chamber is frequently exposed to wind and rain, the electronic and motor components must be individually sealed to prevent damage. The requirement of this additional sealing adds costs to the protection device. Further, even with the extra seals, durability and reliability is often times a concern.

Other problems exist with these prior art designs. At times these devices do not prove strong enough or durable enough to withstand the impact of projectiles which may be carried by the high winds. Further, such prior art systems oftentimes are not capable of easy maintenance and operation because it is difficult to access various working parts. Still further, these systems are susceptible to failure if a projectile, carried by the high winds, impacts the fabric causing terminal stresses to internal mechanisms.

### SUMMARY OF THE INVENTION

In light of the foregoing, it is a first aspect of the present invention to provide an assembly to lock a storm curtain adjacent to an opening in a building.

It is another aspect of the present invention to provide an assembly for covering a building opening, the assembly comprising a shaft positioned at one end of the building opening, a curtain carried by the shaft, a locking mechanism at the opposed end of the building opening from the shaft that selectively holds the curtain in a locked position to cover the building opening, an input for selectively rotating the shaft, and a linking assembly adapted to transfer the input to the shaft to selectively rotate the shaft, wherein the linking assembly includes a failsafe portion designed to fail upon a predetermined impact on the curtain.

Yet another aspect of the present invention is to provide an assembly for covering a building opening for preventing debris from entering a building interior, the assembly comprising a header positioned at one end of the building opening, the header having an outer chamber and an inner chamber separated by a sealing wall, and the input being positioned at least partially in the inner chamber, a shaft positioned in the outer chamber of the header, a rotational input mechanism positioned in the inner chamber of the header, wherein the sealing wall prevents moisture and debris from entering the building interior through the header.

Still another aspect of the present invention is an assembly for covering a building opening, the assembly comprising a shaft positioned at one end of the opening, a cover carried by the shaft, a stop positioned proximate to the shaft, wherein the curtain is coupled to the shaft such that when the curtain is completely unrolled, the stop is adapted to engage the curtain and the shaft and prevent the curtain from counter-winding on the shaft.

Yet another aspect of the present invention is an assembly for covering a building opening for preventing debris from entering a building interior, the assembly comprising a header positioned at one end of the building opening, the header having an outer chamber and an inner chamber separated by a sealing wall, a shaft positioned in the outer chamber of the header, a curtain carried by the shaft, a locking mechanism at the opposed end of the building opening from the shaft that selectively holds the curtain in a locked position to cover the building opening, an input mechanism positioned at least partially in the inner chamber of the header for selectively rotating the shaft, and a linking assembly adapted to transfer a rotational input from the input mechanism to the shaft to selectively rotate the shaft, wherein the linking assembly includes a failsafe portion designed to fail upon a predetermined impact on the curtain and the sealing wall prevents moisture and debris contacting the input mechanism.

Still another aspect of the present invention is a method of profiling movement of a movable barrier comprising providing a motor assembly with a control circuit to control movement of a barrier, initiating a profiling mode at the control circuit, moving the barrier to a first position, setting a first limit, moving the barrier in an opposite direction toward a second position until a predetermined parameter is detected by the control circuit, setting a second limit, moving the barrier in another direction to a third position until the predetermined parameter is detected by the control circuit, and setting a third limit that is between the first limit and the second limit.

Yet another aspect of the present invention is a method of operating a barrier operator comprising moving a barrier between paths defined by an open limit position, a close limit position, and a lock limit position, wherein the lock limit position is not in the path defined between the open and close limit positions.

### BRIEF DESCRIPTION OF THE DRAWINGS

For a complete understanding of the objects, techniques and structure of the invention, reference should be made to the following detailed description and accompanying drawings, wherein:

FIG. 1 is a perspective view of a window having a storm curtain assembly made in accordance with the present invention.

FIG. 2 is a front elevational view of the assembly of FIG. 1.

FIG. 3 is a top plan view of the assembly of FIG. 1.

FIG. 4 is a side elevational view of the assembly of FIG. 1.

FIG. 5 is a side, fragmentary sectional view of the header and storage roll assembly of the storm curtain assembly.

FIG. 6 is an exploded view showing the storage roll assembly and front cover of the header.

FIG. 7 is an exploded view of the storage roll assembly.

FIG. 8 is an exploded view of the drive unit, rear cover and cord cover.

FIG. 9 is a fragmentary perspective view of the header and drive unit with the rear cover removed.

FIG. 10 is a perspective view of the drive unit.

FIG. 11 is an exploded view of the drive unit and motor adaptor.

FIG. 12 is an exploded view of the drive unit and motor adaptor from an alternative angle.

FIG. 13 is a fragmentary rear perspective view of the rear cover and cord.

FIG. 14 is an exploded view of the motor assembly.

FIG. 15 is a partially exploded fragmentary perspective view of the header with the motor assembly removed.

FIG. 16 is a fragmentary perspective view of the header with the motor assembly installed and rear cover removed.

FIG. 17 is a fragmentary perspective view of the header with two motor assemblies installed.

FIG. 18 is a somewhat schematic sectional view of the curtain, header and locking sill showing a projectile prior to impact.

FIG. 19 is a somewhat schematic sectional view, like that of FIG. 18, showing the projectile after impact with the curtain.

FIG. 20 is a somewhat schematic sectional view, like that of FIG. 18, showing the projectile at maximum penetration.

FIG. 21 is a somewhat schematic sectional view, like that of FIG. 18, showing the projectile after repulsion by the curtain.

FIG. 22 is a partially exploded view of the locking sill, derailleur and channel.

FIG. 22A is an enlarged view of the locking channel of the locking sill. FIG. 23 is an exploded view of the derailleur and derailleur insert.

FIG. 24 is a perspective view of the derailleur and derailleur insert.

FIG. 25 is a side elevational view of the derailleur and derailleur insert.

FIG. 26A is a somewhat schematic, sectional view showing the curtain being lowered and at a position just about to enter the locking area.

FIG. 26B is a view sequentially following FIG. 26A in the locking procedure.

FIG. 26C is a view sequentially following FIG. 26B in the locking procedure.

FIG. 26D is a view sequentially following FIG. 26C showing the curtain in a first resting position.

FIG. 26E is a view sequentially following FIG. 26D in the locking procedure.

FIG. 26F is a view sequentially following FIG. 26E in the locking procedure showing the curtain in the locked position.

FIG. 26G is a view sequentially following FIG. 26F in the unlocking procedure.

FIG. 26H is a view sequentially following FIG. 26G in the unlocking procedure.

FIG. 26I is a view sequentially following FIG. 26H in the unlocking procedure showing the curtain in a second resting position.

FIG. 26J is a view sequentially following FIG. 26I in the unlocking procedure.

FIG. 26K is a view sequentially following FIG. 26J in the unlocking procedure.

FIG. 27 is a flowchart showing a profiling sequence initiated by a control circuit to profile the rotational direction of the motor with respect to the linear direction of the storm curtain.

FIG. 28 is a flowchart showing the operational steps taken by the control circuit to move the curtain.

FIG. 29 is a perspective view of a window having a storm curtain assembly made in accordance with another embodiment of the present invention.

FIG. 30 is a side, fragmentary sectional view of the header and storage roll assembly of the storm curtain assembly of FIG. 29.

FIG. 31 is an exploded view showing the storage roll assembly and front cover of the header.

FIG. 32 is an exploded view of the storage roll and end supports.

FIG. 33 is a partially exploded fragmentary perspective view of the header with the motor and battery assemblies removed.

FIG. 34 is an exploded view of the motor and battery assemblies.

FIG. 35 is a somewhat schematic sectional view of the curtain, header and sill showing a projectile prior to impact.

FIG. 36 is a somewhat schematic sectional view, like that of FIG. 35, showing the projectile after impact with the curtain.

FIG. 37 is a somewhat schematic sectional view, like that of FIG. 35, showing the projectile after repulsion by the curtain.

FIG. 38 is an exploded view of the locking bar.

FIG. 39 is a sectional view of the locking bar.

FIG. 40 is a partially exploded view of the sill and derailleur insert.

FIG. 41 is an enlarged partially exploded view of the sill and derailleur insert.

FIG. 42 is an enlarged view of the locking channel of the sill.

FIG. 43A is a somewhat schematic, sectional view showing the curtain being lowered and at a position just about to enter the sill.

FIG. 43B is a view sequentially following FIG. 43A in the locking procedure.

FIG. 43C is a view sequentially following FIG. 43B in the locking procedure showing the curtain in a first resting position.

FIG. 43D is a view sequentially following FIG. 43C in the locking procedure.

FIG. 43E is a view sequentially following FIG. 43D in the locking procedure showing the curtain in the locked position.

FIG. 43F is a view sequentially following FIG. 43E in the unlocking procedure.

FIG. 43G is a view sequentially following FIG. 43F in the unlocking procedure showing the curtain in a second resting position.

FIG. 44 is a sectional view of the header and stop.

FIG. 45 is a sectional view of the header and stop showing the stop engaging an upturned edge of the curtain.

FIG. 46 is a flowchart showing an alternative profiling sequence initiated by a control circuit to profile the rotational direction of the motor with respect to the linear direction of a barrier such as the storm curtain.

FIG. 47 is a flowchart showing the operational steps taken by the control circuit to move the curtain.

FIG. 48 is a flowchart showing alternative operational steps taken by the control circuit to move the curtain.

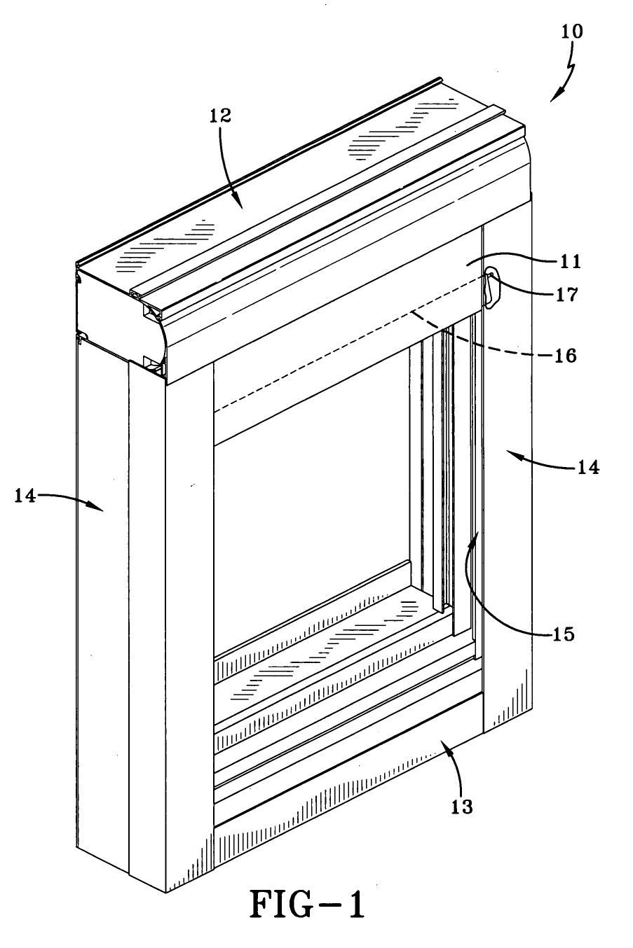

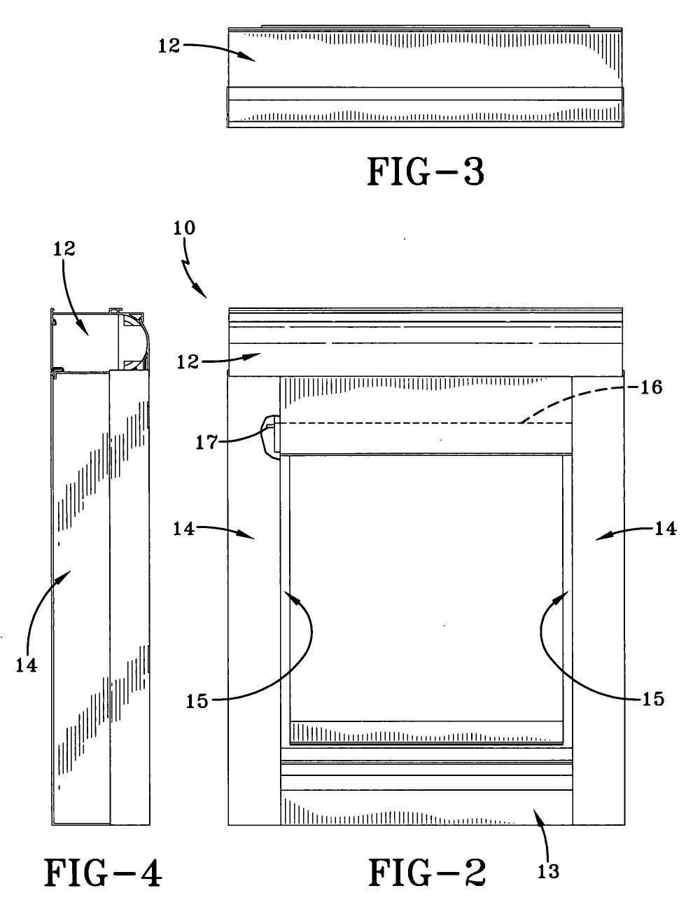

### PREFERRED EMBODIMENTS FOR CARRYING OUT THE INVENTION

A storm curtain assembly made in accordance with the present invention is generally indicated by the numeral 10 and includes a fabric curtain 11 which is selectively movable to obstruct a building opening, such as a window, door or the like. Storm curtain assembly 10 selectively prevents solar heat gain and protects the opening from intrusion due to high winds or windborne debris, such as a window. Curtain 11 is made of a material which is water resistant and which can withstand the forces of wind and airborne debris, as are often encountered in a hurricane or the like. Examples of such fabric are disclosed in U.S. patent application Ser. No. 11/190,114 filed on Jul. 25, 2005, to which reference is made for whatever details are necessary to understand the present invention. A locking bar 16, which is generally rectangular in the end view, is secured to the bottom end of curtain 11. Bar 16 is rigid and extends across the entire lateral width of curtain 11, providing a sturdy surface to enable locking across the bottom of curtain 11, (see FIG. 7). Bar 16 includes pins 17 which extend outwardly from each side thereof.

Storm curtain assembly 10 is mounted in the surrounding framework of a building opening and may be integrated into the frame of a standard window. Assembly 10 may be installed during new construction or may be installed in pre-existing buildings. Assembly 10 includes a header unit 12 which is positioned proximate the top of the building opening. A locking sill 13 is positioned proximate the bottom of the building opening and is adapted to receive and selectively secure the bottom of curtain 11 as will be described later in more detail. A pair of vertical tracks 14 extend between header unit 12 and locking sill 13 and provide channels 15 which guide bar 16 and correspondingly curtain 11 as it is moved up and down.

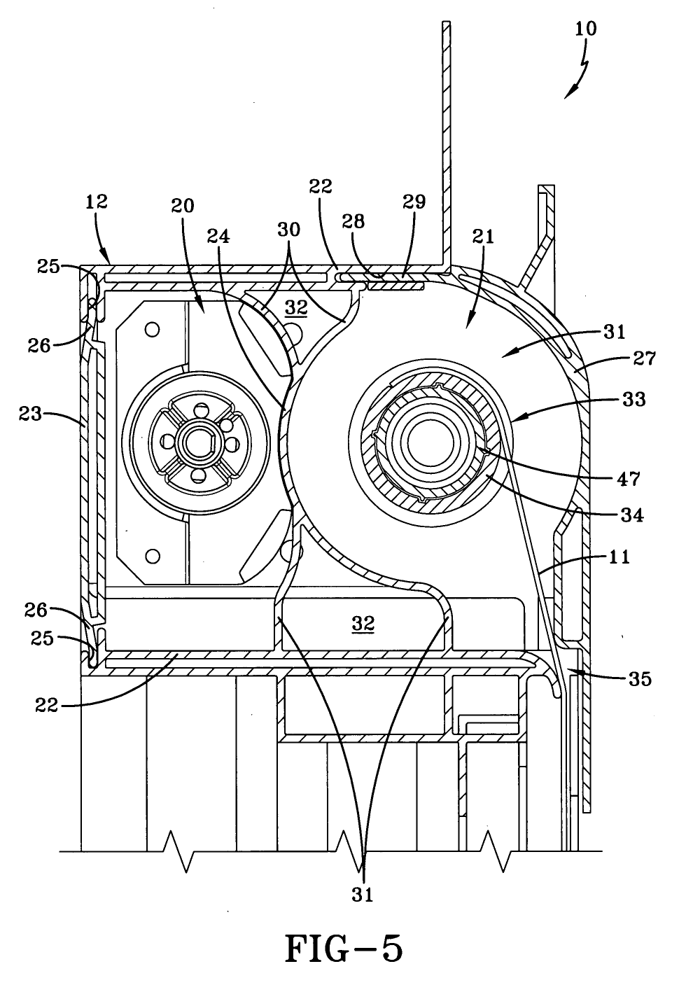

Referring now to FIG. 5, header unit 12 includes a pair of separated chambers. An interior chamber 20 is defined by a housing 22, inner cover 23, and sealing wall 24. Housing 22 is secured to a building frame in any manner known in the art, and may include interior grooves 25 which receive an extending lip 26 of inner cover 23. Inner cover 23 may thus be selectively secured to, and removed from housing 22 to provide access to interior chamber 20.

An exterior chamber 21 is defined by housing 22, sealing wall 24 and an outer cover 27. Housing 22 may include exterior grooves 28 which receive an extending lip 29 of outer cover 27. Outer cover 27 may thus be selectively secured to, and removed from housing 22 to provide access to exterior chamber 21.

Sealing wall 24 is a contiguous wall that provides an environmental seal between interior chamber 20 and exterior chamber 21. Sealing wall 24 is generally curved having an upper “Y” shaped fork 30 and a lower “Y” shaped fork 31. Forks 30 and 31 form buffer areas 32 which enable various mounting holes to be drilled in sealing wall 24 without compromising integrity of the seal. Sealing wall 24 is secured to housing 22 or may be integral therewith. Thus, if rain or debris penetrates into exterior chamber 21, sealing wall 24 prevents such materials from entering interior chamber 20. As will become apparent, the inclusion of segregated chambers helps prevent water and wind from penetrating the interior of the building. Further, sealing wall 24 provides protection to sensitive drive components, some of which may include electronics, which may become inoperable if exposed to water or other debris.

Exterior chamber 21 houses a storage roll assembly generally indicated by the numeral 33, which carries curtain 11. As best shown in FIG. 5, curtain 11 is secured to a shaft 34 at its upper end. A length of curtain 11 is wrapped around shaft 34 and exits exterior chamber 21 at opening 35. Shaft 34 is carried at each end by end supports 36. End supports 36 serve to carry shaft 34 and to mechanically link shaft 34 to a rotational input mechanism. Each end support 36 includes a first housing 37 and an opposed second housing 38. First housing 37 includes an exterior spindle 39 and an interior spindle 40. Exterior spindle 39 receives a driven gear 41 which is rotatable thereon. Interior spindle 40 receives a drive gear 42 which is rotatable thereon. When housing 37 and 38 are assembled, gears 41 and 42 are enclosed therein. As is evident from FIG. 7, drive gear 42 and driven gear 41 are mechanically intermeshed so that clockwise rotation of drive gear 42 will cause corresponding counter-clockwise rotation of driven gear 41. In an alternative embodiment, gears 41 and 42 may be spaced and rotationally coupled by a chain loop. In still another embodiment, gears 41 and 42 may be replaced with cylinders having circumferentially spaced projections. The cylinders may be spaced and a belt may be provided to rotationally couple the cylinders. The belt may include spaced grooves which intermesh with the teeth of the cylinders, to prevent belt slip.

Shaft 34 is supported by, and rotationally coupled to, each driven gear 41 so that when driven gears 41 rotate, shaft 34 rotates therewith. Thus, shaft 34 is rotatable to draw curtain 11 upward or downward to selectively uncover or cover the building opening. Shaft 34 includes a hollow interior which receives a bias member 45. Bias member 45 may be in the form of a torsion spring which is coupled at its first end 46 to shaft 34 via an insert 47, which is received within and is rotationally coupled to shaft 34. A second end 48 of bias member 45 is coupled to a fixed point relative to housing 22. In the present embodiment, second end 48 is secured to exterior spindle 39. Bias member 45 is pre-tensioned to provide a counterbalance against the weight of curtain 11. In other words, at all times bias member 45 rotationally biases shaft 34 to draw curtain 11 upward.

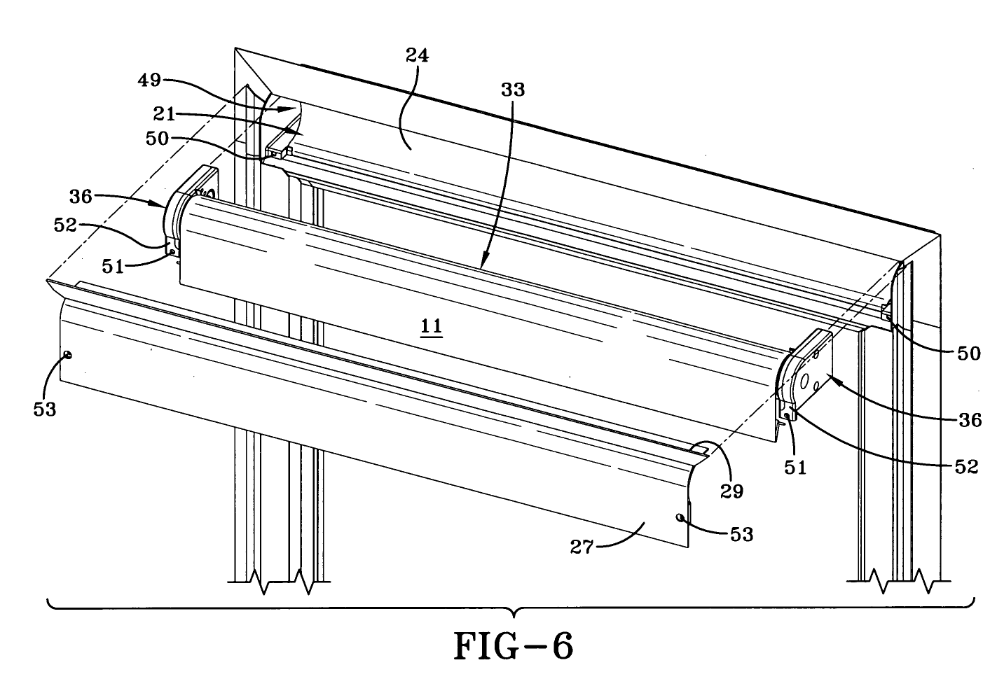

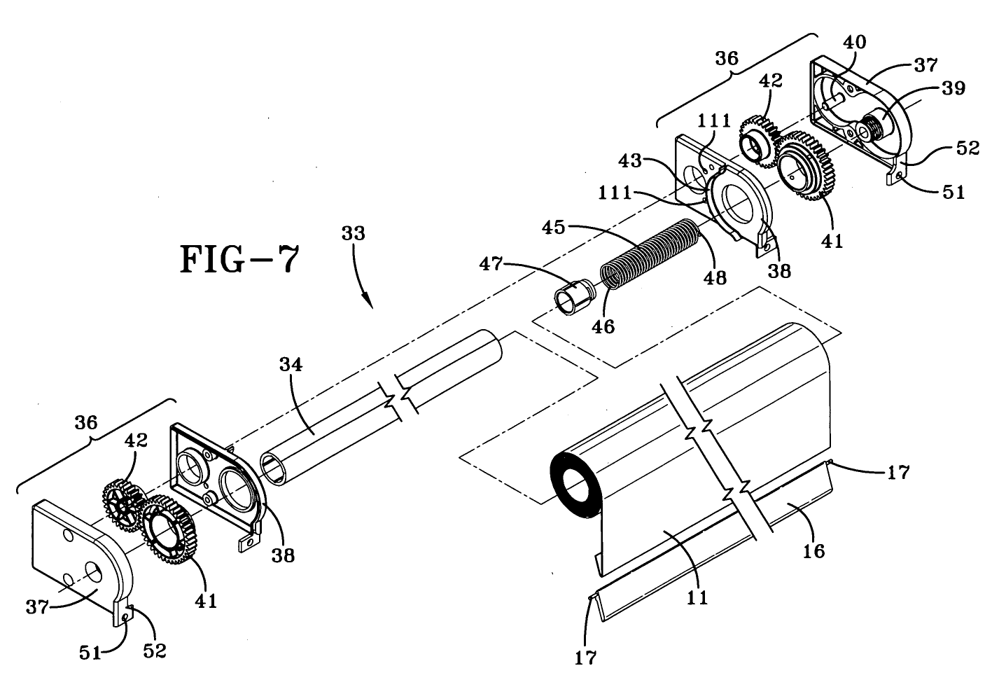

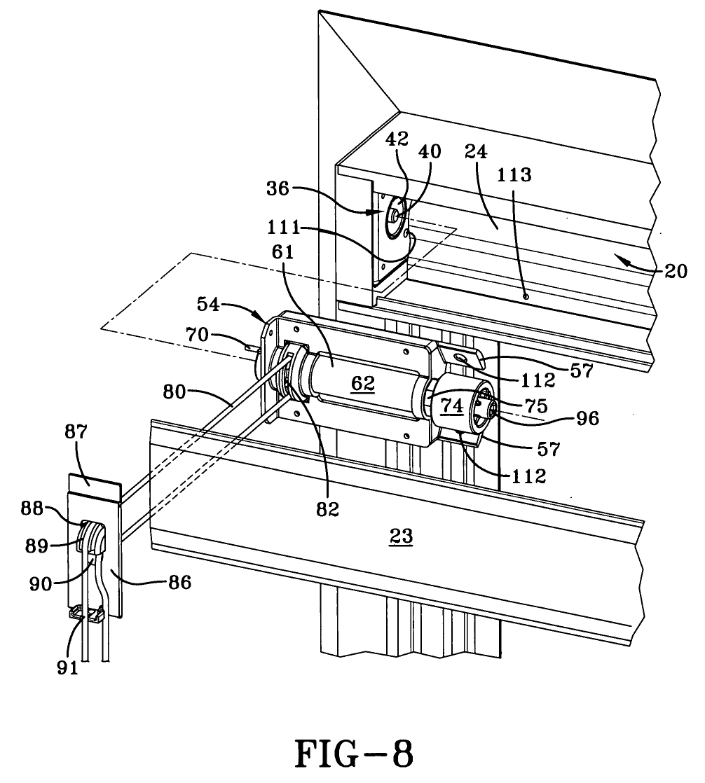

As shown in FIG. 6, sealing wall 24 does not extend completely to the side walls of housing 22. Rather, a support opening 49 is provided at each side of sealing wall 24. End supports 36 are received through support openings 49 and positioned so that driven gear 41 resides in exterior chamber 21 and drive gear 42 resides in interior chamber 20. A sealing flange 43 is provided on second housing 38 which extends inwardly therefrom. Sealing flange 43 is shaped to match the profile of sealing wall 24. Thus, when assembled, sealing flange 43 abuts sealing wall 24 preventing water or debris from entering support opening 49.

Housing 22 is provided with a pair of holes 50 vertically aligned with support openings 49. End supports 36 likewise each include a hole 51 positioned on a downwardly extending tab 52. Finally, outer cover 27 includes a pair of holes 53 alignable with holes 50 in housing 22. Thus configured, end supports 36 may be inserted into support openings 49, thereby aligning housing holes 50 with end support holes 51. Outer cover 27 may then be installed with extending lip 29 being received in exterior groove 28 and outer cover holes 53 being aligned with end support holes 51. When assembled in the aforementioned manner, a bolt may be inserted through the aligned holes and secured to housing 22. It should be evident that such a configuration allows easy disassembly and replacement of storm curtain parts.

Referring now to FIG. 8, which shows the interior chamber 20 with inner cover 23 removed, it can be seen that end support 36 extends into interior chamber 20. Drive gear 42 is thus exposed to interior chamber 20 and translates rotational inputs from interior chamber 20 to shaft 34 via driven gear 41. A drive unit 54 is secured within interior chamber 20 and is coupled to drive gear 39. As will be hereinafter described, drive unit 54 enables both manual and motorized operation of storm curtain assembly 10.

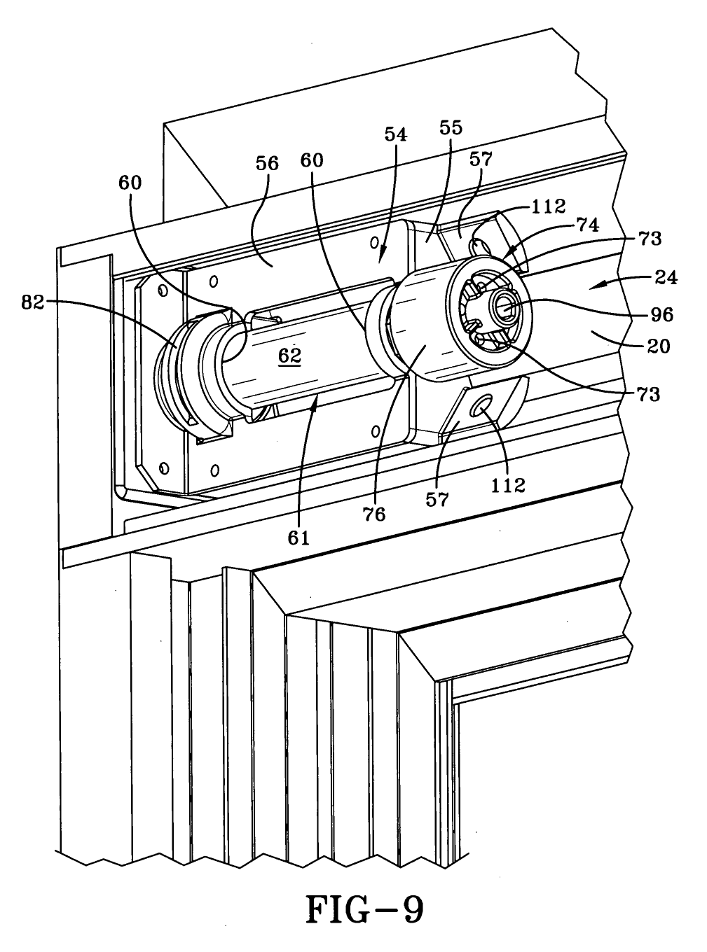

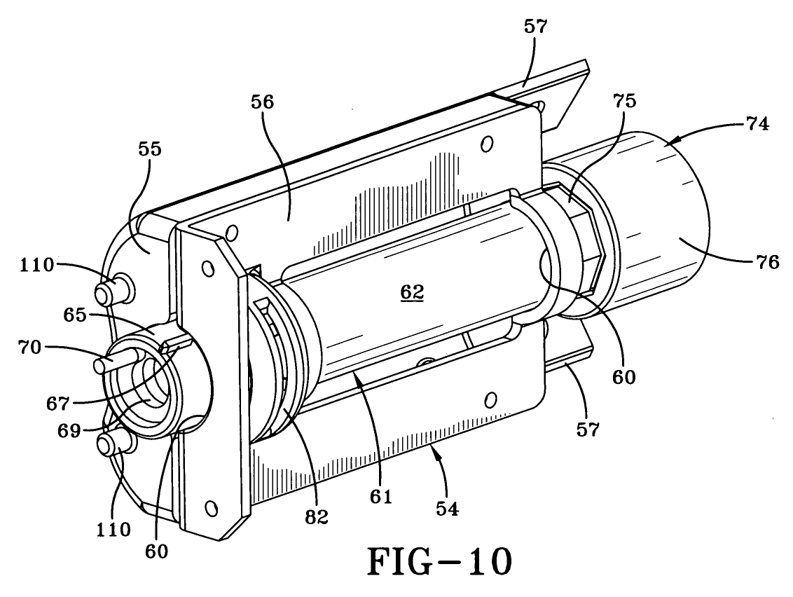

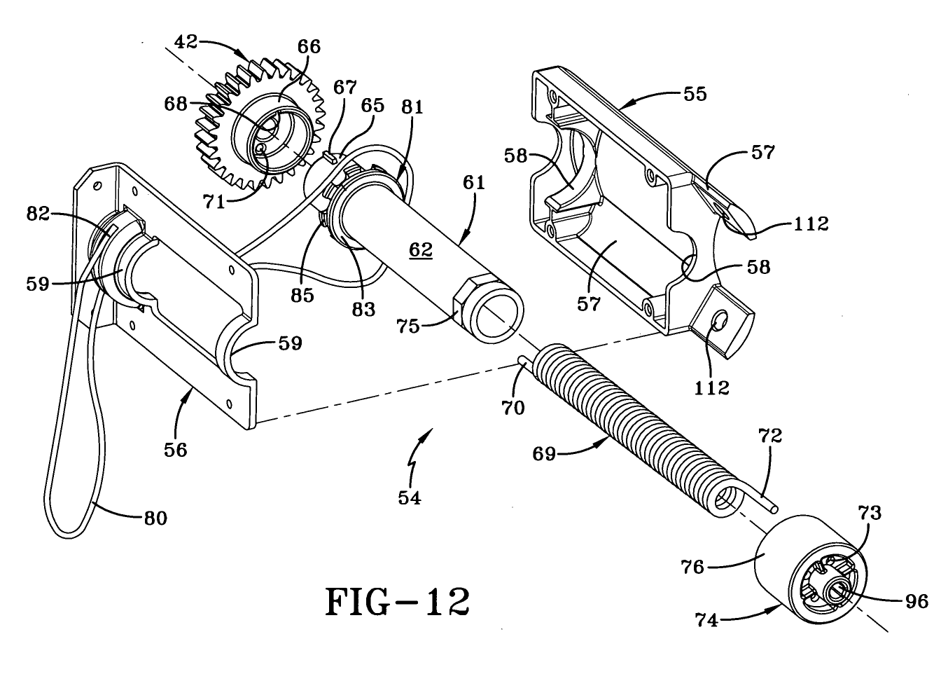

Referring now to FIGS. 9-12, drive unit 54 includes a first housing half 55, which is secured to a second housing half 56. First housing half 55 includes a pair of curved walls 57 which are adapted to rest against the curved surface of sealing wall 24. A pair of semi-circular portions 58 are provided which align with semi-circular portions 59 of second housing half 55. When assembled, a pair of spaced bushings 60 are formed by semi-circular portions 58 and 59. A drive sleeve 61, which is generally cylindrical, is received within first and second housing halves 55 and 56. Drive sleeve 61 is hollow and includes a smooth cylindrical central portion 62 which is rotatable within bushings 60. In this manner, first and second housing halves receive and support drive sleeve 61, allowing it to rotate therein.

Drive sleeve 61 is rotatably coupled to drive gear 42 and includes a smooth cylindrical end portion 65 which is received within an extending sleeve 66 of drive gear 42. An axially projecting shear key 67 is provided on end portion 65 and is received in a corresponding key slot 68 on drive gear 42. In this manner, drive sleeve 61 is rotationally coupled to drive gear 42.

Drive sleeve 61 is also coupled to drive gear 42 by an impact spring 69. Spring 69 is positioned within the hollow interior of drive sleeve 61. A first end 70 extends axially and is received within a hole 71 in drive gear 42. A second end 72 extends axially and is received in a hole 73 in a motor adaptor 74. Drive sleeve 61 includes a mating surface 75 which may be, for example, hexagonal or octagonal. Motor adaptor 74 includes a shaped sleeve 76, which is adapted to slidingly engage mating surface 75 and rotationally couple thereto. Thus, motor adaptor 74 is rotationally coupled to both drive sleeve 61 and impact spring 69. In this manner, impact spring 69 is coupled to drive gear 42 directly and drive sleeve 61 via motor adaptor 74. It should, however, be appreciated that, while key 67 remains unsheared, impact spring 69 does not effect the operation of drive unit 54.

When assembled, impact spring 69 is pre-tensioned by inserting spring 69 into hole 71 in drive gear 42 and into hole 73 in motor adaptor 74. Motor adaptor 74 can then be rotated until desired tension is achieved and then pressed over mating surface 75 to rotationally couple thereto. Spring 69 is tensioned so that if shear key 67 is detached from drive sleeve 61, due to a sudden large impact against curtain 11, spring 69 opposes the weight of curtain 11 and maintains tension on curtain 11. Further, spring 69 maintains tension on curtain 11 to prevent curtain 11 from unlocking from a locked position, as will be described later in more detail.

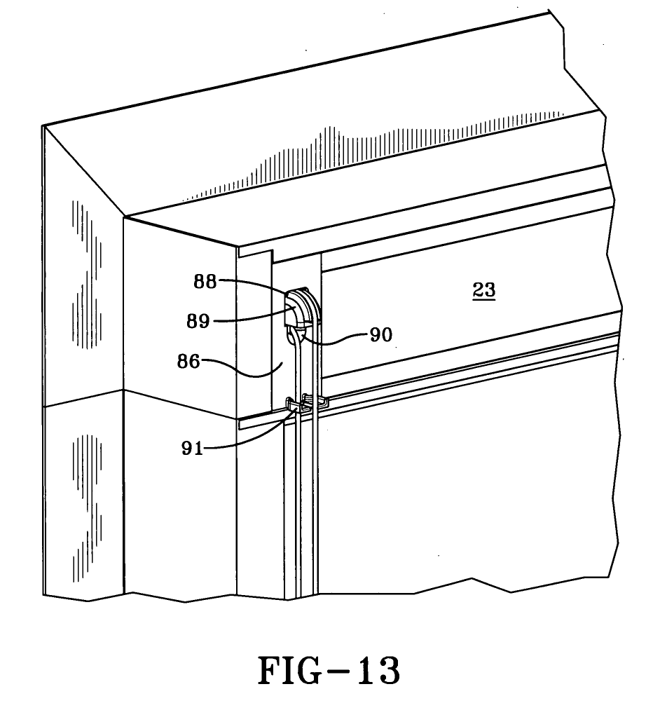

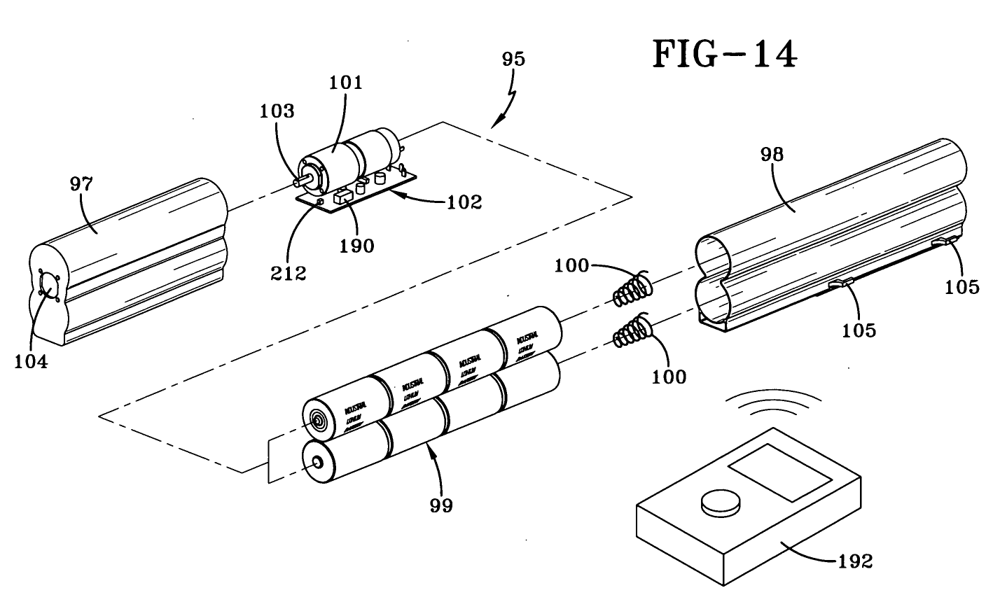

As discussed above, storm curtain 10 may be manually or electronically operated. Manual operation may be accomplished by a pull cord 80, which wraps around drive sleeve 61 at a cord sprocket 81, which is aligned with an accurate slot 82 in second housing potion 56. Cord sprocket 81 includes a first flange 83 which is provided with axially facing teeth 84 and a second notched flange 85 which is spaced axially from first flange 83. Pull cord 80 is received through slot 82, around drive sleeve 61 between first and second flanges 83 and 85, and back out slot 82. A cord cover 86, shown in FIGS. 8 and 13, may be provided and includes a tab 87, which is received within interior groove 25 of housing 22. Cord cover 86 includes a first aperture 88 which receives cord 80 therethrough. Contiguous with first aperture 88 is a curved ramp 89 over which cord 80 travels. A second aperture 90 is located below curved ramp 89 where cord 80 is fed back to drive sleeve 61. In this manner, a portion of cord 80 is accessible to the interior of the building. If a user wishes to operate storm curtain 10 manually, he or she simply pulls on the exposed cord 80 from within the building to cause drive sleeve 61 to rotate. A locking cleat 91 is provided so that when the desired location or tension is achieved, cord 80 is pressed into locking cleat 91 thereby preventing further cord movement.

Storm curtain 10 may also be electronically operated by a motor assembly 95. Motor assembly 95 rotationally couples to a socket 96 on motor adaptor 74 as will be hereinafter discussed. Motor assembly 95 includes a first casing 97 which is slidably received within a second casing 98. Casings 97 and 98 are generally in the shape of merged cylinders which in end view are generally in the shape of a figure eight. Casings 97 and 98 are adapted to receive a pair of stacked batteries 99 therein. A spring 100 is positioned within second casing 98 between each battery stack 99 and the closed end of second casing 98. In one embodiment, spring 100 may be a tapered helical spring which enables a large range of deflection and is compressible to a substantially flat orientation. Positioned at the opposed end of the battery stacks 99 are a motor 101 and a control circuit 102, which controls operation of motor 101 and, as such, the position of curtain 11. A shaft 103 extends from motor 101, through an aperture 104 at the closed end of first casing 97. It should thus be evident that motor assembly 95, when assembled, is compressible to reduce its overall length. As will hereinafter be discussed, this compressive feature enables motor assembly 95 to be easily mounted within interior chamber 20.

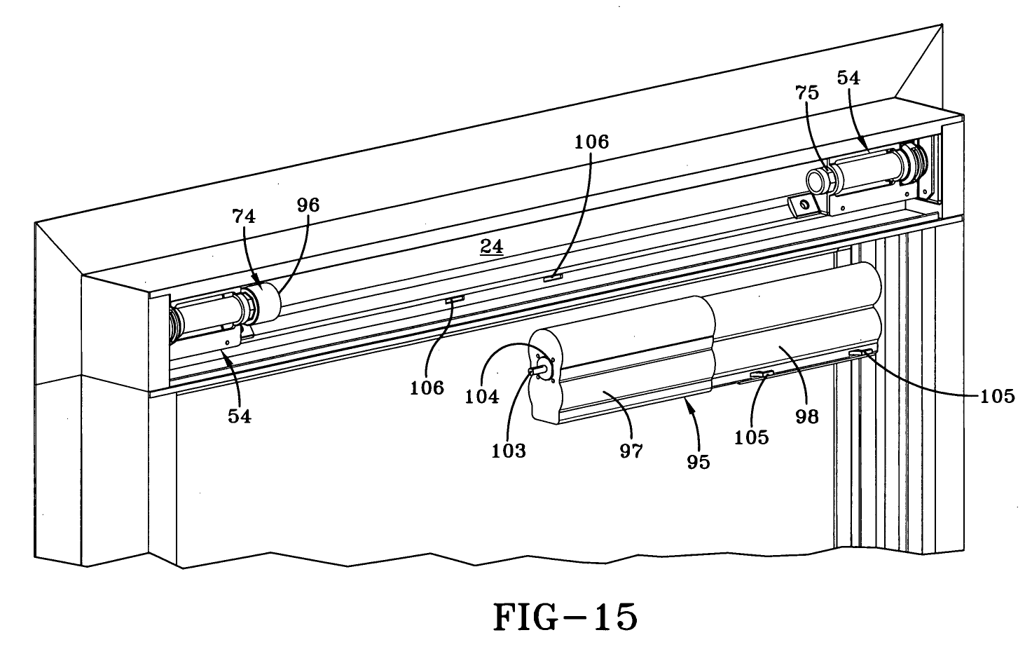

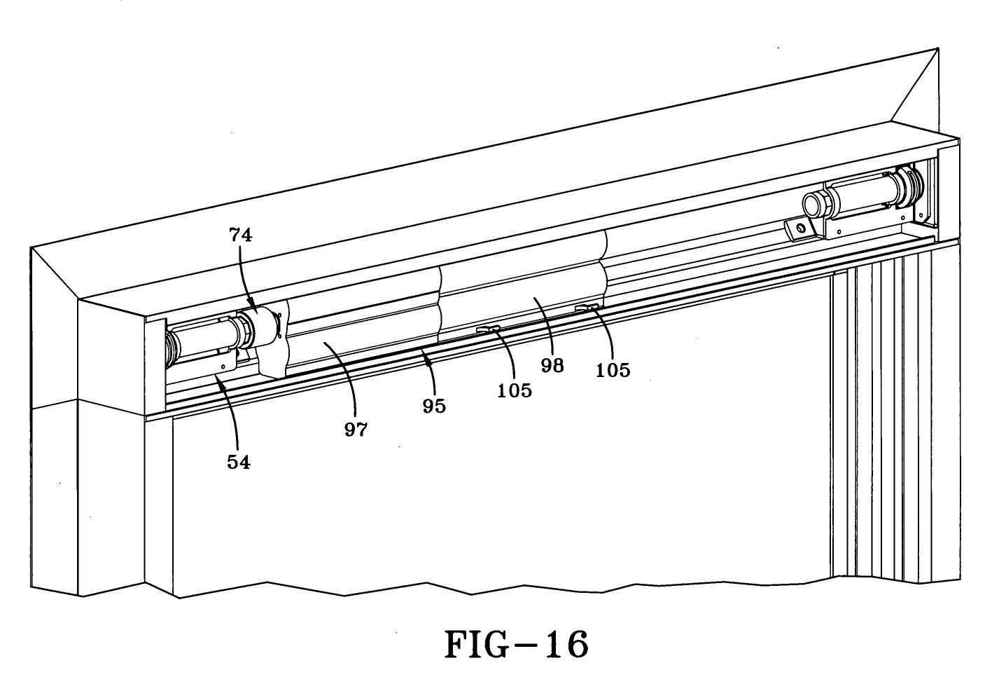

Second casing 98 includes two pairs of “L” shaped projections 105 that extend from each side. Projections 105 are adapted to be received in motor mating slots 106 in sealing wall 24. Referring now to FIGS. 15 and 16, one method of installing motor assembly 95 may be to insert shaft 103 into socket 96 of motor adaptor 74. Thereafter, motor assembly 95 may be slightly compressed, causing first casing 97 to slide further into second casing 98. Compression is accomplished by the installer who applies an inward force to the end of casing 98. While under this force, springs 100 will compress and the overall length of motor assembly 95 is reduced. In this state, projections 105 may be placed within mating slots 106. Finally, compression of motor assembly 95 is released, allowing springs 100 to extend. Projections 105 are thereafter secured within mating slots 106 and retained there because springs 100 bias the first and second casings 97 and 98 to move axially away from each other. In this manner, shaft 103 is retained within socket 96 and projections 105 are secured within mating slots 106. Thus configured, motor assembly 95 is ready for operation.

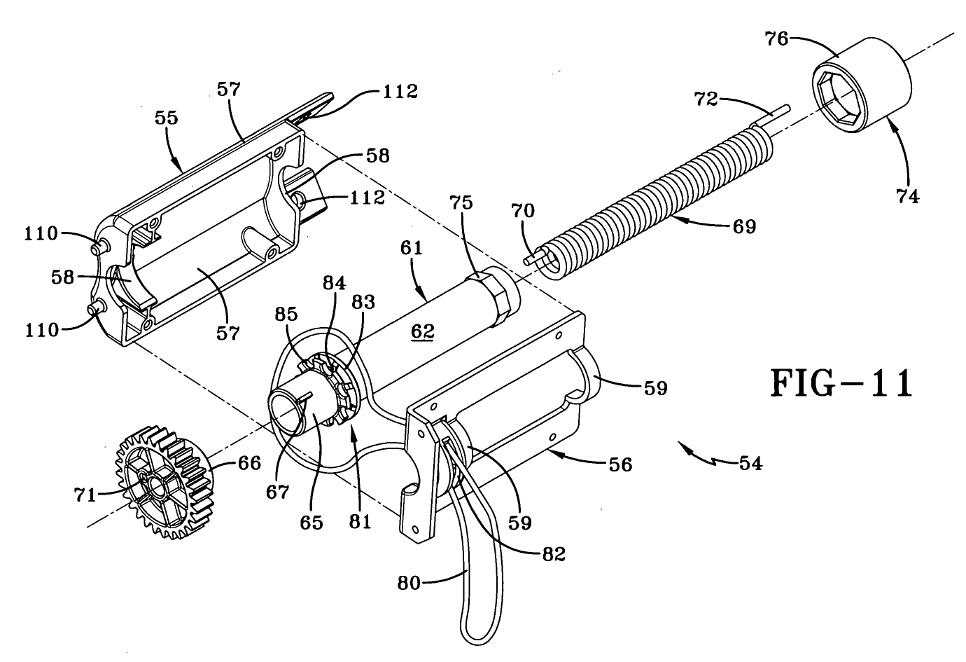

It should be appreciated that drive unit 54 may be positioned at either or both sides of interior chamber 20 to enable added flexibility during installation. Thus, drive unit 54 includes a pair of mounting pins 110 (FIG. 11) which are received in mounting holes 111 (FIG. 8) in end supports 36. Curved walls 57 of drive unit 54 rest flush against sealing wall 24 and include holes 112 that are aligned with corresponding a hole 113 in sealing wall 24. A Bolt (not shown) may be received through holes 112 and 113 to secure drive unit 54 to sealing wall 24. Drive unit 54 may be secured to either end support 36 by merely flipping the unit over. Further, because projections 105 are included on both sides, motor assembly 95 may be oriented to engage a drive unit 54 on either side by merely flipping it over. This flexibility is advantageous as installers may position the components in various orientations depending upon installation requirements.

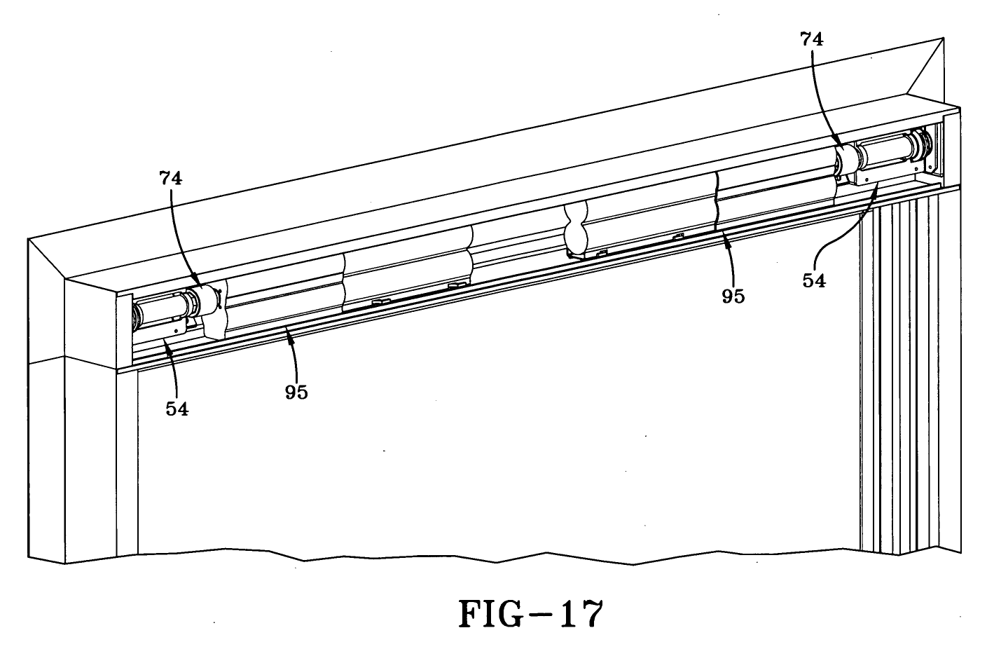

An alternative embodiment is shown in FIG. 17, wherein a pair of drive units 54 and corresponding motor assemblies 95 are shown. Multiple motor assemblies 95 may be required when enclosing larger building openings or when it is desired to draw greater tension on curtain 11.

The above disclosed motor configurations provide several additional benefits. First, the motor assembly 95 and drive unit 54, are serviceable and installable from the interior of the building. This may be desirous when weather conditions make outside access difficult. Further, when storm curtains 10 are installed in elevated openings, as would be the case in multi-story buildings, accessing windows from the exterior may prove difficult and dangerous. The present invention eliminates this problem and provides easy access from the inside. It should also be appreciated that in the present invention, the motor assembly 95 and storage roll assembly 33 are separate, spaced elements in contradistinction to many prior curtain designs. Such prior designs include a motor assembly, typically a tube type motor, positioned within a storage roll assembly and therefore motor servicing and access cannot be achieved without first removing the storage roll assembly and curtain from the outside of the structure. Such prior designs are therefore difficult to service and maintain and the present invention advantageously provides easy access to motor assembly 95.

Normal curtain movement is accomplished by rotating drive sleeve 61, either by pulling on cord 80 or by applying a current to electric motor 101. In either event, drive sleeve 61 rotates within first and second housings 55 and 56. This rotation is translated to drive gear 42 via the interaction of shear key 67 and key slot 68. Drive gear 42 translates rotational movement to driven gear 41 through the mechanical intermeshing of the respective gears. Likewise, because driven gear 41 is coupled to shaft 34, rotation of drive gear 41 causes rotation of shaft 34. Rotation of shaft 34 causes upward or downward movement of curtain 11, depending upon the direction of rotation. When the operator desires the building opening to be unobstructed, the operator, through cord 80 or motor 101, causes shaft 34 to wind up substantially all of curtain 11 into exterior chamber 21. Likewise, when the operator desires the opening to be covered, curtain 11 is unwound until it is received in locking sill 13. In this manner, curtain 11 may selectively obstruct the building opening for privacy purposes, to prevent solar heat gain. Curtain 11 may also be lowered and locked in locking sill 13 to prevent window penetration by wind borne objects as will be hereinafter discussed.

Locking sill 13 receives and selectively secures the curtain 11 via locking bar 16. Thus, when a high wind event occurs, such as a hurricane, curtain 11 may be lowered and locked in locking sill 13. Once locked, tension may be applied to curtain 11 by further pulling on cord 80 or by motor 101. Once desired tension is achieved, pull cord 80 is secured to locking cleat 91, or in the case of motor operation, motor 101 prevents additional rotation. Thus secured, curtain 11 protects the building interior.

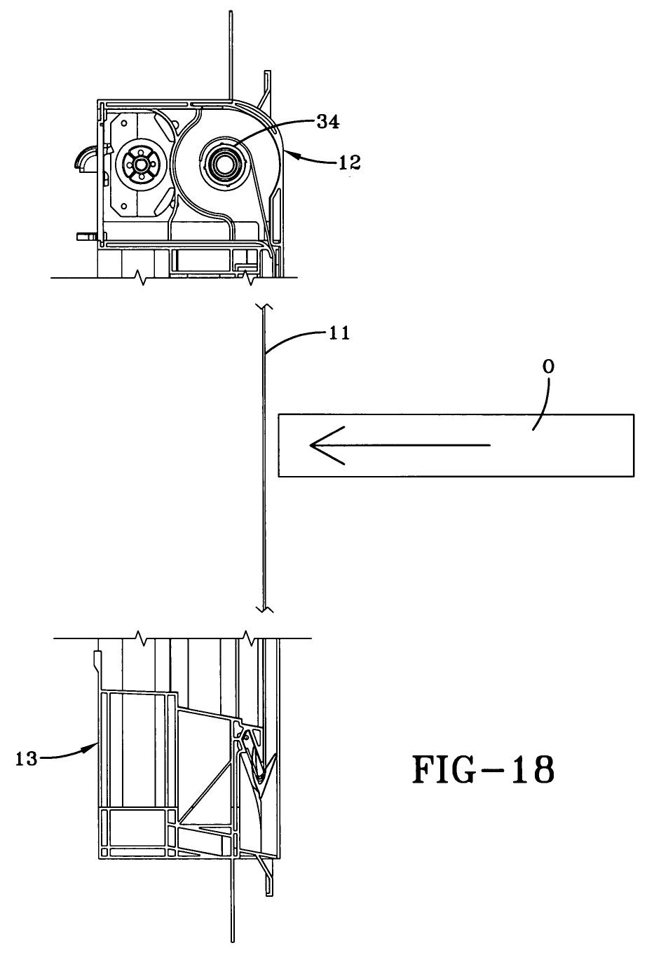

Referring now to FIG. 18, curtain 11 is shown as being secured to locking sill 13 and is tensioned in preparation for the high wind event. During high wind events, objects O may be carried by the wind and penetrate the opening if no protective membrane is provided. If this occurs, severe damage to the interior of the building may occur in the form of water damage, or damage from the flying debris. Further, when such a penetration occurs, the roof may become compromised due to increased pressure differentials between the interior and exterior of the building.

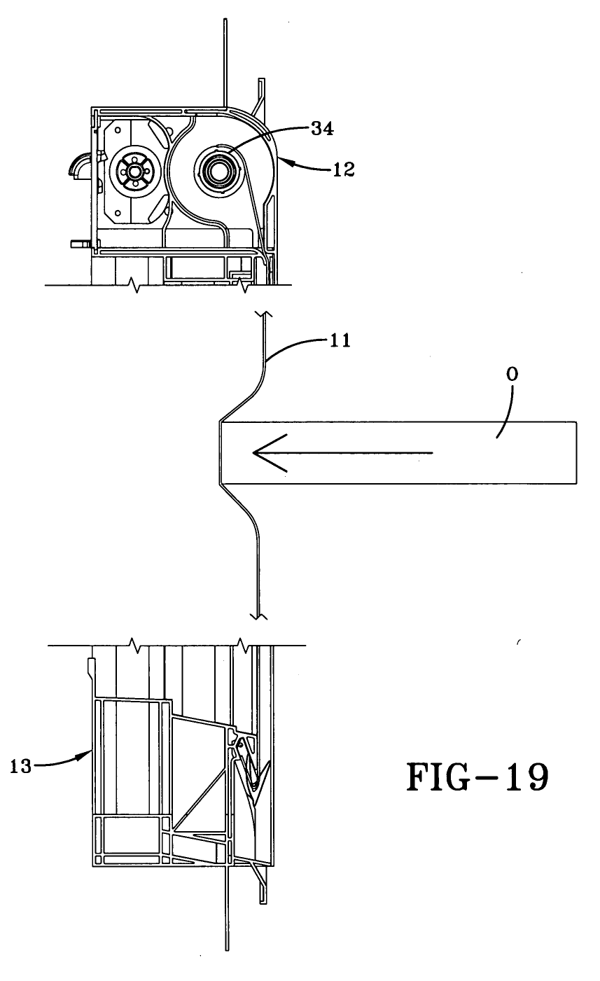

FIG. 19 shows object O after initially impacting curtain 11. In such a case, if the magnitude of impact is not too great, shear key 67 will withstand the force and the locked drive sleeve 61 maintains tension on curtain 11 to repel the object O. If the magnitude of impact is greater, shear key 67 will be severed from drive sleeve 61 and drive sleeve 61 is thereafter rotationally coupled to drive gear 42 via impact spring 69. Because impact spring 69 is pre-tensioned, positive tension is maintained on curtain 11 even after key 67 shears. Impact spring 69, because of its resilient nature will, however, allow drive gear 42, under the impact of object O, to rotate. Thus, as is evident if FIG. 19, shaft 34 will rotate to allow additional curtain material to exit header unit 12.

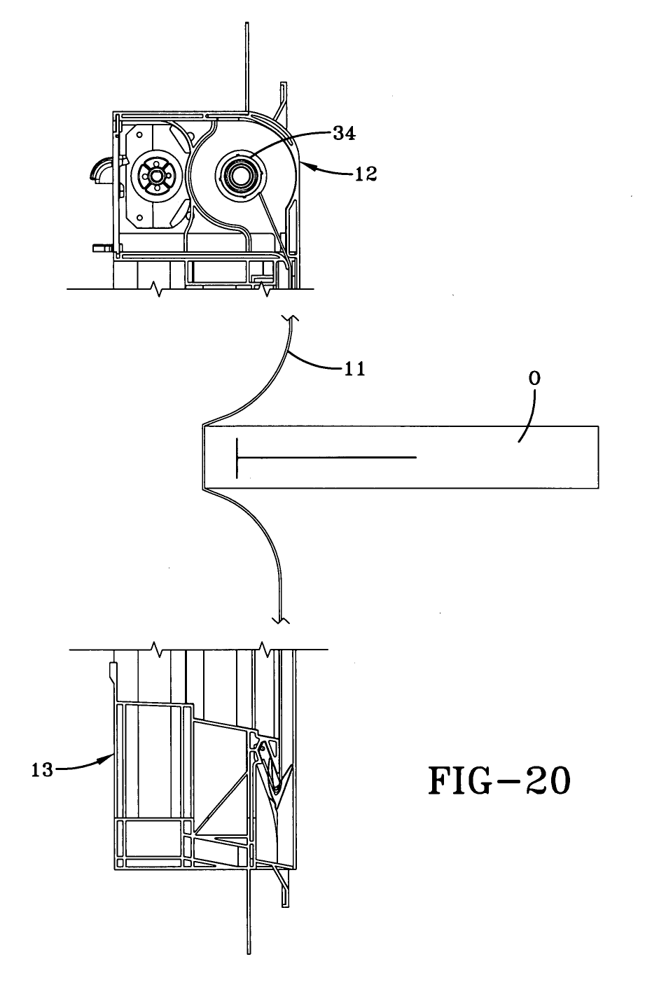

Referring now to FIG. 20, object O has now penetrated to its maximum depth and at this point, shaft 34 has rotated to let out all additional curtain material. At this point curtain 11 is substantially perpendicular to shaft 34. When maximum penetration occurs, both bias member 45 and impact spring 69 bias curtain 11 upward to maintain tension thereon. It should be appreciated that, in cases of severe impact, the underlying window may break. However, curtain 11 still maintains a substantially watertight seal around the opening, preventing water damage or damage due to windborne debris. Further, curtain 11 may prevent catastrophic damage that would otherwise occur if a window or door is breached and the wind pressures compromise the structure's integrity, particularly the roof.

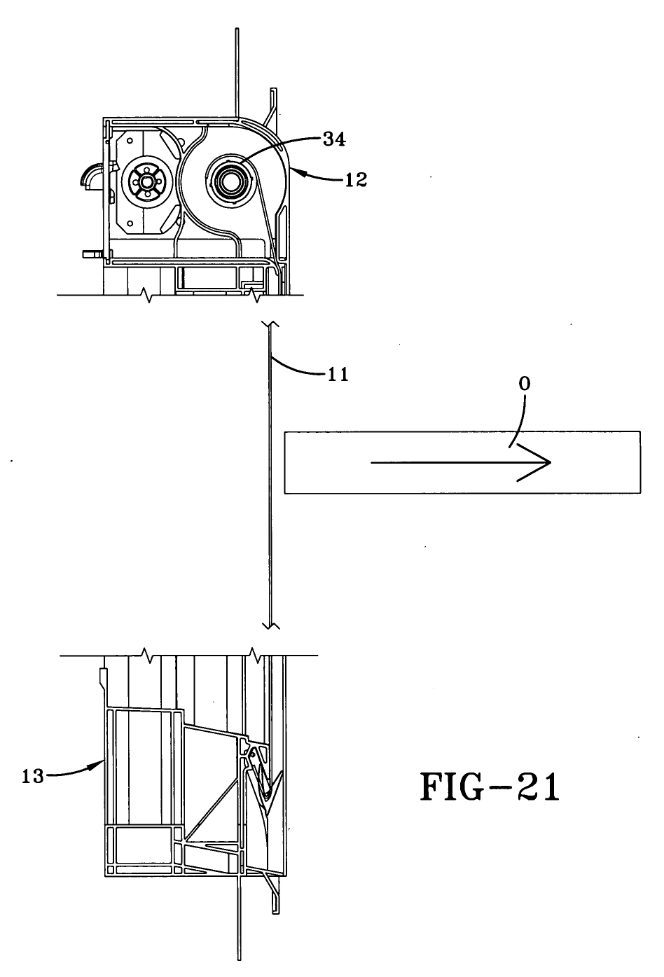

Referring now to FIG. 21, the bias force of bias member 45 and impact spring 69 propels object O away from curtain 11 and again rotates shaft 34 to draw in a portion of curtain 11. Thereafter, the combined bias force of both bias member 45 and impact spring 69 maintains tension on curtain 11 and prevents dislocation from locking sill 13.

In this manner, storm curtain assembly 10 prevents building penetration. Further, the motor and other drive mechanisms are protected by design of drive unit 54. Specifically, if high impact forces are realized against curtain 11, key 67 shears and the impact force is absorbed by impact spring 69. Impact spring 69, in combination with bias member 45, maintains tension on curtain 11 so that it continues to protect the interior of the building and does not unlock from locking sill 13. It should further be appreciated that, even after key 67 is sheared, storm curtain assembly 10 is still operable and a user may raise and lower curtain 11. It will, however, be evident to the user that key 67 is dislocated due to the slower response of the drive mechanism. It is recommended that upon such an event, drive sleeve 61 be replaced with one having a functioning shear key 67.

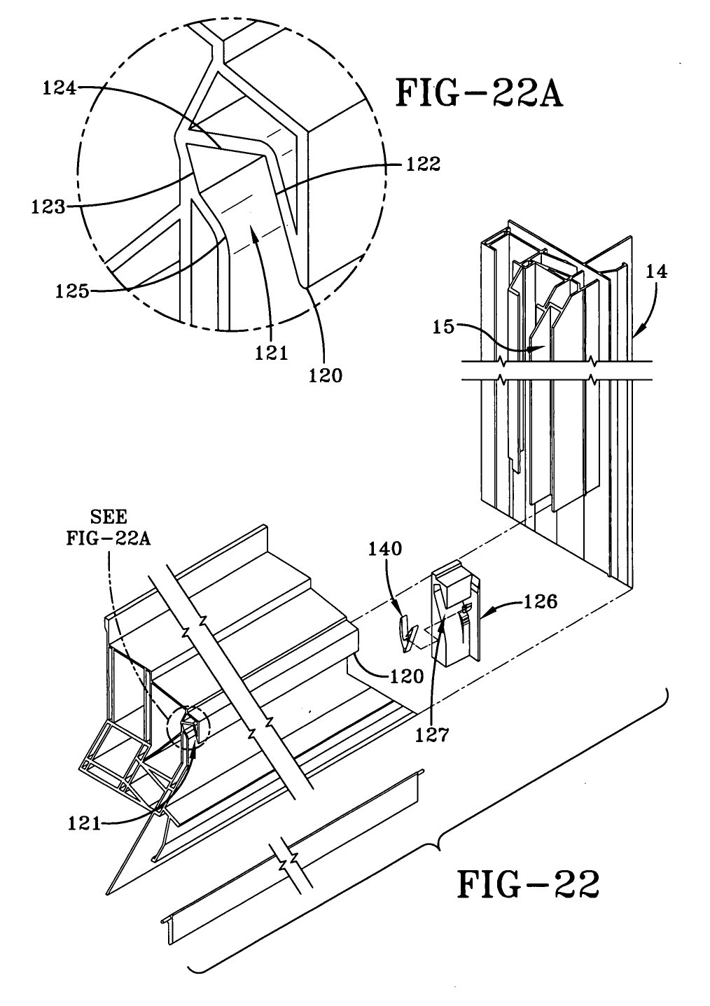

One manner in which the curtain 11 is locked to sill 13 is shown in FIG. 22 and 23. As discussed above, vertical channels 15 are formed along the length of each vertical track 14 and extend from the area of header unit 12 downwardly, terminating at locking sill 13, as at a lip 120. Vertical channels 15 are sufficiently wide to allow locking bar 16 to always be at an oblique angle, preventing binding when curtain 11 is moved up or down. Further, the angled orientation of bar 16 prevents rattling as curtain 11 is exposed to gusting winds. A locking channel 121 is formed along the entire lateral length of sill 13 and extends into vertical tracks 14. Channel 121 is formed with a side wall 122 spaced from a side wall 123 by an end wall 124. Side wall 122 thus extends from lip 120 to end wall 124, and side wall 123 extends from end wall 124 to a lip 125. As is evident from FIG. 22, locking channel 121 is disposed at an angle relative to channel 15.

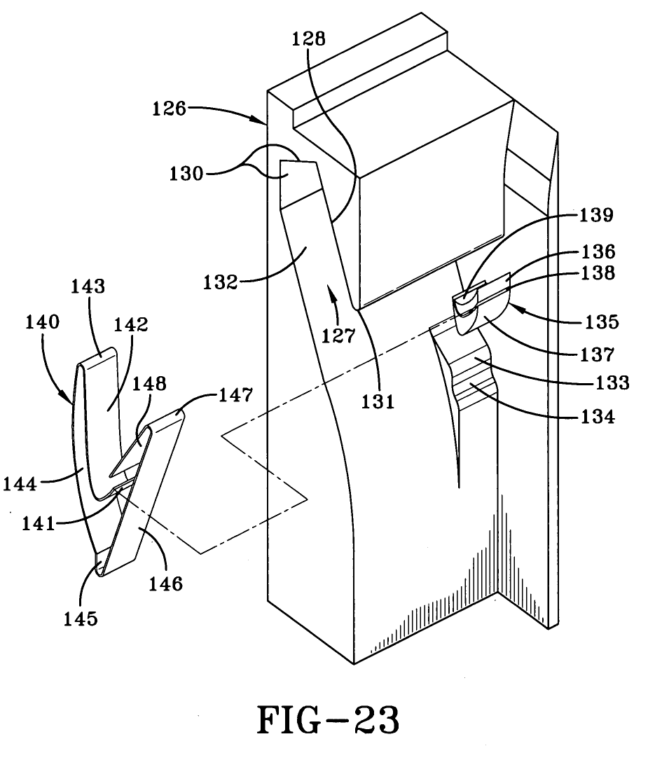

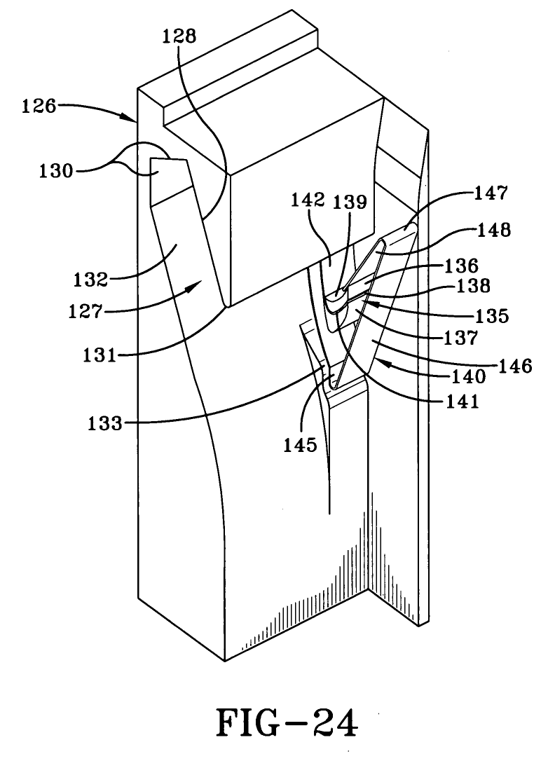

A derailleur insert, shown in FIGS. 23-25 and generally indicated by the numeral 126, is secured to the wall of each vertical track 14. Each derailleur insert 126 includes a derailleur channel 127, which is generally larger in area than locking channel 121 of locking sill 13. Derailleur channel 127 is formed with a side wall 128 spaced from a side wall 132 by an end wall 130. Side wall 128 thus extends from a lip 131, which may be generally aligned with lip 125, to end wall 130. Side wall 132 my be slightly curvilinear and extends from end wall 130 to the bottom surface of sill 13. As is evident from FIG. 22, derailleur channel 127 is disposed at an angle relative to channel 15. A derailleur support portion 133 extends upwardly from side wall 132 and includes a groove 134.

A derailleur holder 135 extends inwardly from derailleur insert 126 partially into derailleur channel 127. Derailleur holder 135 includes an upper portion 136 and a lower portion 137 separated by a slot 138. Upper portion 136 is generally hook shaped and includes a curved top surface 139. A derailleur, generally indicated by the numeral 140 is provided which is formed of a flattened resilient material such as aluminum or the like. Derailleur 140 includes an attachment leg 141 which is received within slot 138 to secure derailleur 140 to derailleur insert 125. A first leg 142 extends upwardly from attachment leg 141 and terminates at a tip 143. A second leg 144 extends downwardly from tip 143 to a notched portion 145, which is adapted to rest against derailleur support portion 133. A third leg 146 extends upwardly from notched portion 145 and terminates at a tip 147. Finally, a fourth leg 148 extends downwardly from tip 147 and rests against curved top surface 139. It should be appreciated that bar 16 is sized so that a portion extends into derailleur channel 127, but only pins 17 extend far enough to contact derailleur 140 and derailleur support portion 133.

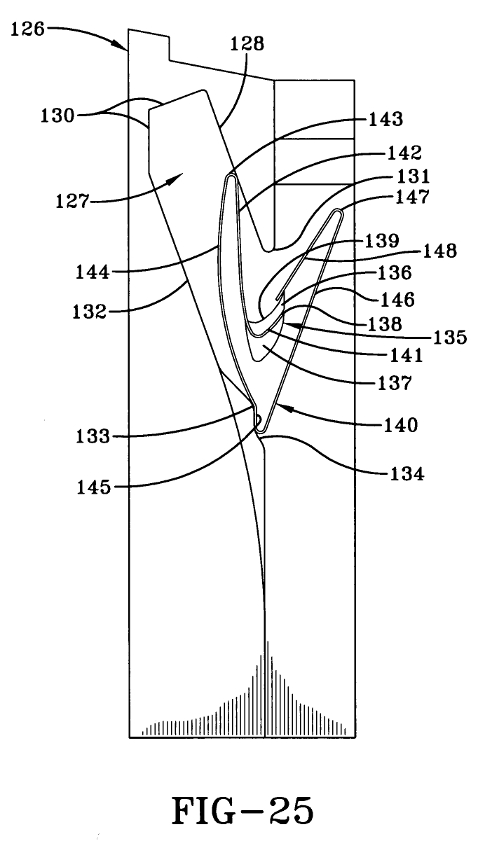

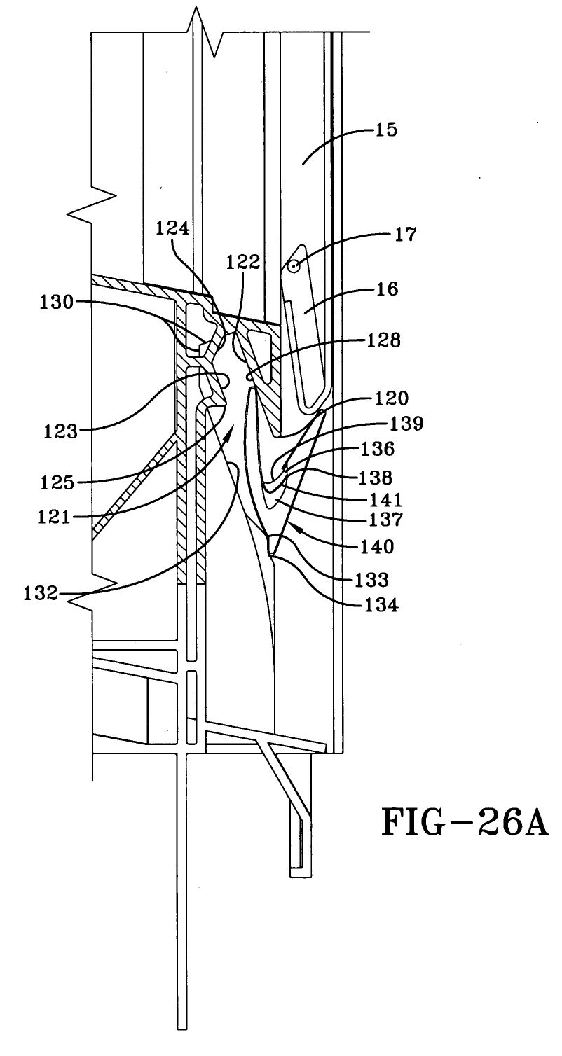

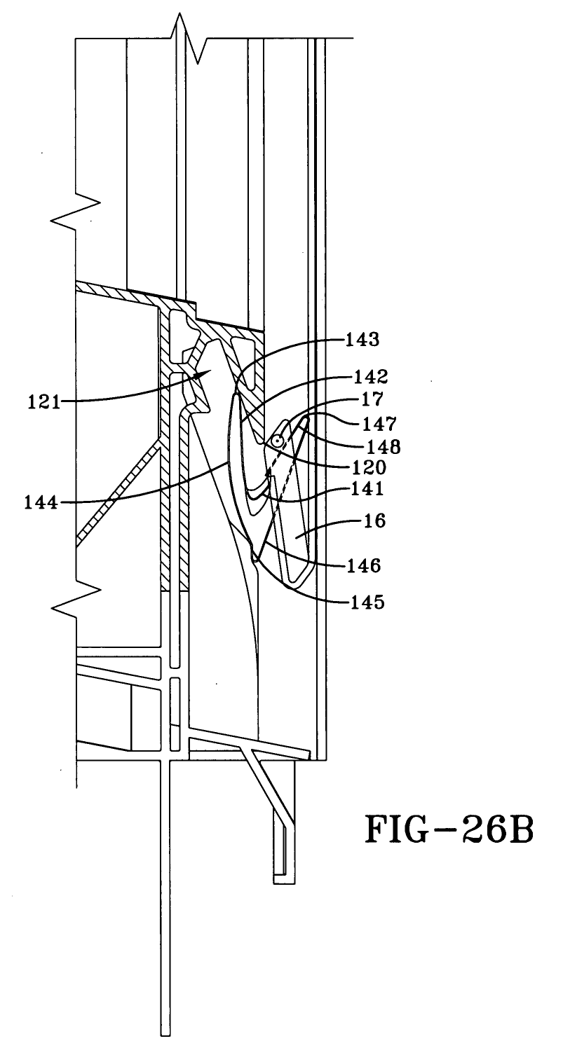

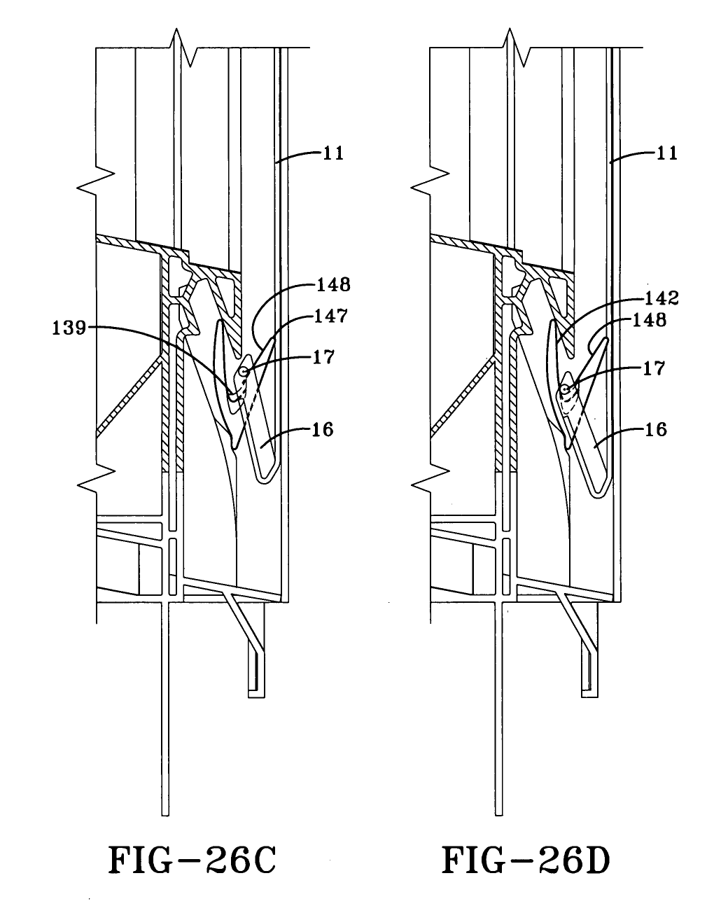

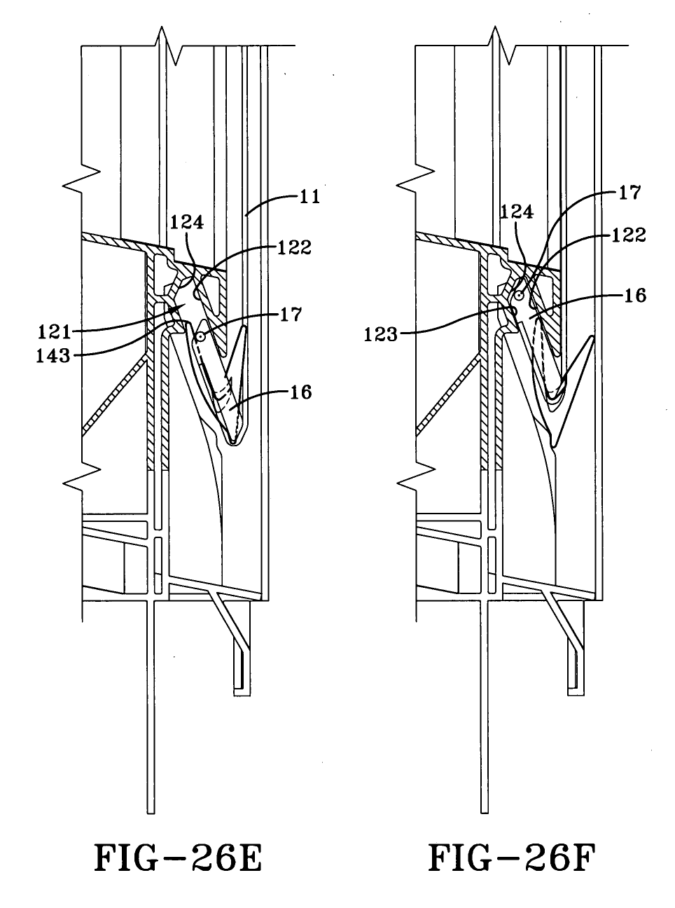

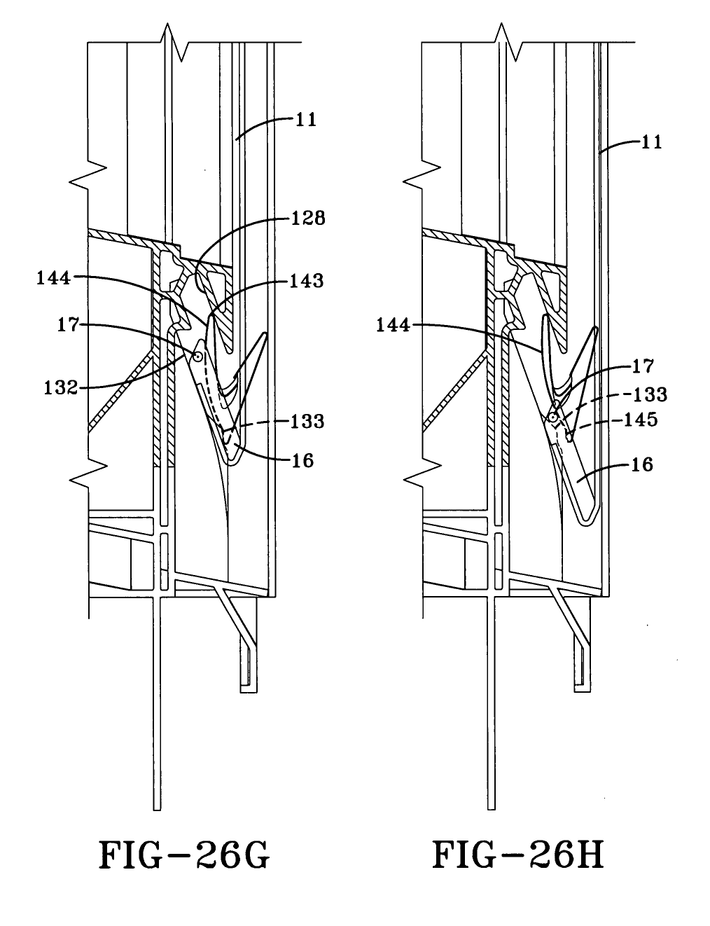

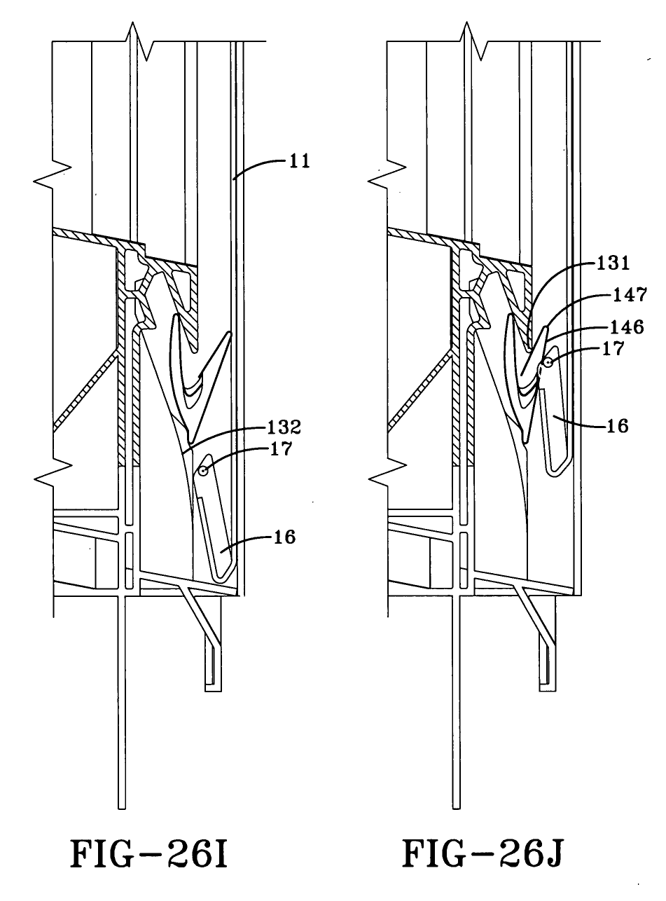

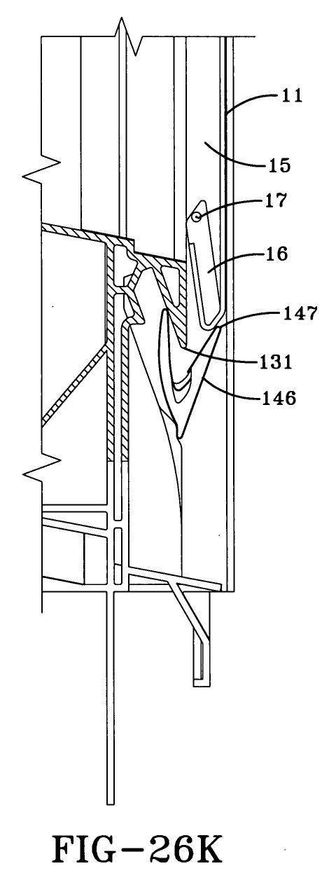

The manner in which locking bar 16 is utilized to lock curtain 11 across the entire sill 13 is best shown with reference to the sequential views 26A-K. As shown in FIG. 26A, as curtain 11 moves downwardly, bar 16 moves down channel 15, and as it moves past lip 120, pins 17 which extend laterally outward from bar 16 contact the fourth leg 147 of derailleur 140 (FIGS. 26B and 26C). At this point, each pin 17 is directed along each fourth leg 148 which in turn causes bar 16 to pivot forward (counter-clockwise). Pivoting motion is further aided by the weight of bar 16, which biases bar 16 to pivot forward. Because curtain 11 is wrapped around bar 16 in the J-shaped orientation shown in FIG. 26A, and because curtain 11 is a flexible material, bar 16 will naturally tend to tip forwardly. Downward movement of curtain 11 is terminated at a first resting position when pin 17 bottoms out in the derailleur holder 135 (FIG. 26D). At this point, because pins 17 rest on derailleur holder 135, the weight of the bar is removed from curtain 11. Because curtain 11 is counterbalanced, removal of the weight of bar 16 translates into greater resistance to the manual operator, or greater strain on the motor. This increased resistance indicates to the manual operator or to the motor circuitry to reverse the direction of the curtain.

Upon reversal of the curtain direction, bar 16 is pulled upward into locking channel 121 (FIG. 26E). As it does so, first leg 142 to pivots forward but continues to press bar 16 against side wall 122 so that bar 16 does not pivot completely out of locking channel 121. Bar 16 continues upward until a locked position is achieved and bar 16 contacts end wall 124 (FIG. 26F). At this point a manual operator may apply additional tension to curtain 11 and lock the tension in via locking cleat 91. Likewise, the motor 101 may apply additional tension until a stall condition is achieved. Once in locked position, the storm curtain assembly is prepared for high wind conditions.

When a user wishes to unlock curtain 11, the curtain direction is again reversed and bar 16 is allowed to move downwardly. Once pin 17 clears tip 143 during upward movement, first leg 142 is no longer forced to pivot and now rests against side wall 128. Thus, pin 17 may now pass by derailleur 140 (FIG. 26G). As bar 16 moves downward, the end portions slide along side wall 132. As downward movement continues, pin 17 contacts second leg 144 and forces notched portion 145 away from derailleur support portion 133 to allow pin 17 to pass therebetween (FIG. 26H). Bar 16 finally bottoms out at a second resting position when bar 16 contacts the bottom wall of sill 13 (FIG. 26I). At this point, because curtain 11 is counterbalanced, removal of the weight of bar 16 translates into greater resistance to the manual operator, or greater strain on the motor 101. This increased resistance indicates to the manual operator or to the control circuit 102 to reverse the direction of curtain 11.

Upon reversal of the curtain direction, bar 16 is pulled upward. The natural tendency of bar 16 to pivot forward is now prevented by third leg 146 of derailleur 140 which contacts pin 17 and prevents bar 16 from returning to the locking channel 121. As bar 16 continues to move upward, third wall 146 pivots forward to effectively block a repeated locking cycle (FIG. 26J). Instead, third leg 146 forces bar 16, via pin 17, into a substantially upright position until it clears lip 130 and continues upward along channel 15 (FIG. 26K). In this manner repeated and dependable locking and unlocking cycles may be achieved.

In order to configure the motor assembly 95 to operate the storm curtain 11, a profiling sequence is performed prior to its initial use. The profiling sequence allows the control circuit 102 associated with the motor assembly 95 to associate each rotational direction of the motor shaft 103 with the corresponding upward and downward movements of the storm curtain 11. Control logic maintained by the control circuit 102, as shown in FIG. 14, may be embodied in hardware, software or a combination of both. The control circuit 102 also provides suitable memory storage and timing features to carryout the normal operational functions to be described below. Additionally, the control circuit 102 includes a receiver 190 configured to be responsive to various wired or wireless command signals, such as an up/down command or related command, sent from a suitable remote transmitter 192 capable of generating wireless signals upon an appropriate button actuation. Of course, command signals could be sent via a wired connection. It is also contemplated that the control circuit 102 may be a node that is part of suitable networking hardware and/or software enabling a command signal to be communicated to the motor assembly 95 via a wireless or hardwired networked computing device.

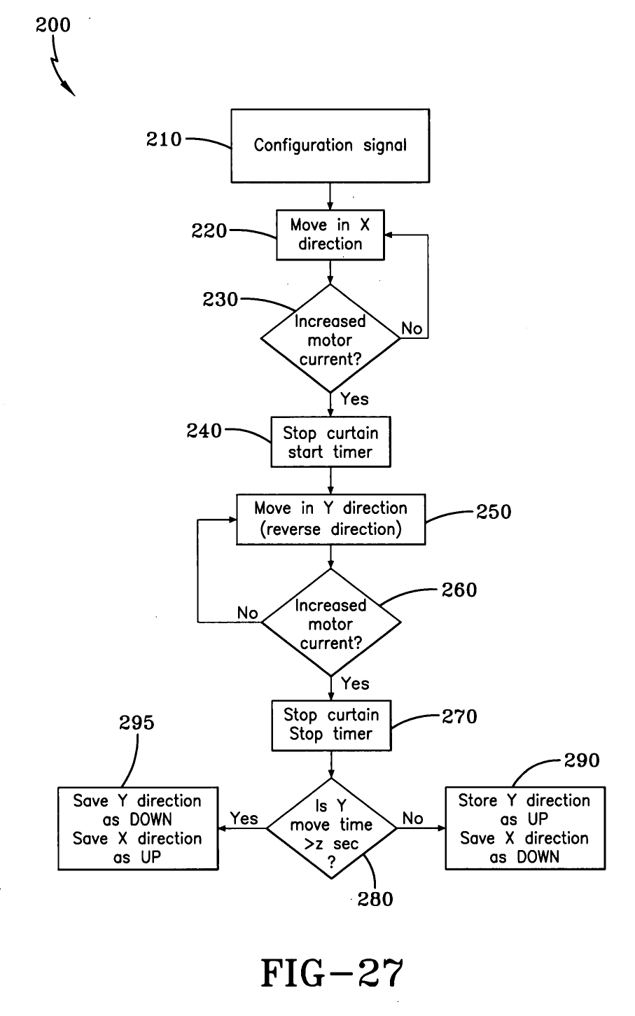

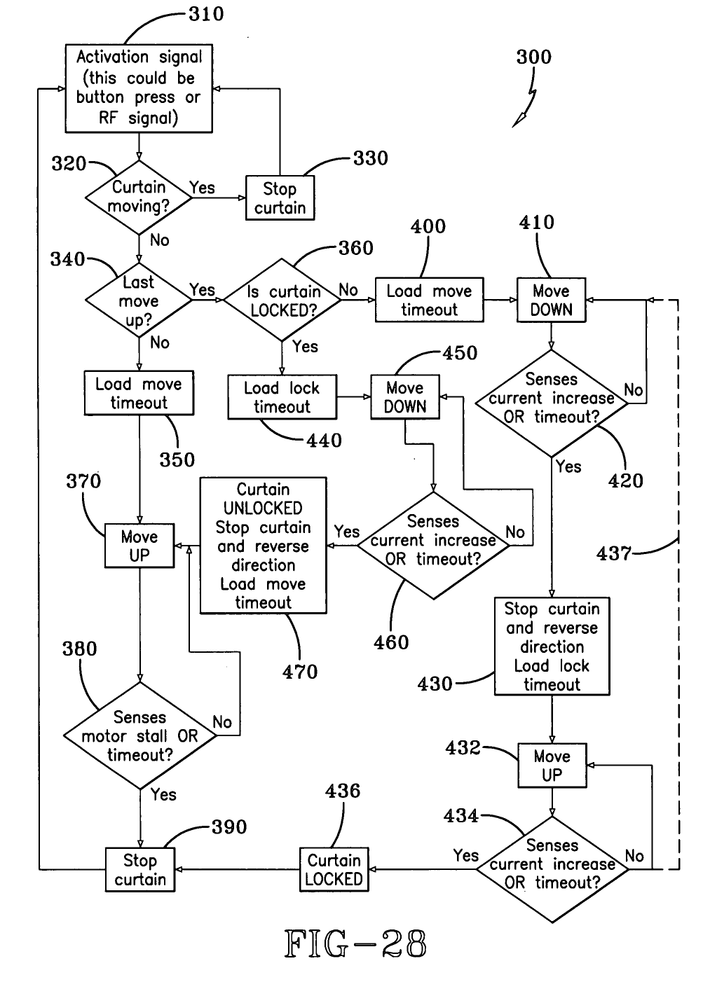

Specifically, the profiling sequence performed by the control logic is generally designated by the numeral 200 as shown in FIG. 27 of the drawings. The skilled artisan will appreciate that a change in the orientation of the motor assembly 95—from one side of the assembly 10 to the other—will result in what is perceived to be the up direction of the curtain 11 and the down direction of the curtain 11. In instances where there are two motor assemblies maintained, it will be appreciated that connections between the two may be made to ensure that they operate in tandem and that the profiling sequence is properly implemented. This could be accomplished by use of an anti-backdrive mechanism for the motor assembly and/or a feedback control method. Or the RF transceivers associated with the respective control circuits could be linked in some manner. At step 210, the profiling sequence is initiated by receipt of an appropriate command or configuration signal sent by a wall station transmitter or the remote transmitter 192 (see FIG. 14). The transmission of the configuration signal may be achieved by actuating an appropriate button provided by the wall station transmitter or the remote transmitter 192 or from a networked computing device. It should be appreciated that the profiling sequence only needs to be performed once prior to placing the storm curtain 11 into service. However, if motor assembly 95 is moved to the other side of interior chamber 20, the user is required to reset, or otherwise initiate the profiling sequence 200 again. It should be appreciated that the profiling sequence 200 may also be reset, or reinitiated when necessary by actuating a reset button 212 that is provided by the control circuit 102, or by depressing a dedicated button or sequence of buttons on the remote transmitter 192.

Continuing to step 220, the storm curtain 11 is moved in a first direction X, which could be either up or down, and the process 200 continues to step 230. At step 230, the process 200, using appropriate sensors associated with the control circuit 102 and/or the motor assembly 95, determines whether the motor assembly 95 is drawing increased electrical current. In other words, the control circuit monitors how much electrical current is required to normally operate the motor assembly. If it is determined that the motor assembly is drawing in excess of that normal amount, it is presumed that the motor is close to or in fact stalling as a result of the curtain reaching an open or closed position limit. In any event, if there is no increase in electrical current drawn by the motor 101, the process 200 returns to repeat steps 220 and 230. But if an increase in electrical current drawn by the motor 101 is detected, then process 200 continues to step 240. At step 240, the movement of the storm curtain 11 is stopped, and a timer maintained by the control circuit 102 is started. Next, the motor assembly 95 moves the curtain 11 in a direction Y that is opposite to or the reverse of direction X, as indicated at step 250. At step 260, the process 200 determines whether the motor assembly 95 is drawing increased electrical current. If the motor 101 is not drawing increased electrical current, then the process 200 returns to repeat steps 250 and 260. However, if the motor 101 is drawing an increased amount of electrical current, then the process 200 continues to step 270, where movement of the storm curtain 11 is stopped and the timer is stopped.

Next, at step 280, the process 200 determines whether the time to complete the movement of the storm curtain 11 in direction Y is greater than a predetermined time period Z, such as 5 seconds for example. If the time to complete the movement of the storm curtain 11 in direction Y is less than the predetermined time period, then the process 200 continues to step 290. At step 290, direction Y is stored by the motor assembly 95, or otherwise associated with the upward movement of the storm curtain 11, while direction X is stored by the motor assembly 95, the control circuit 102, or otherwise associated with the downward movement of the storm curtain 11. However, if the time to complete the movement of the storm curtain 11 in direction Y is greater than the predetermined time period, then the process 200 continues to step 295. At step 295 direction Y is stored by the motor assembly 95, the control circuit 102, or otherwise associated with the downward movement of the storm curtain 11, while direction X is stored by the motor assembly 95, the control circuit 102, or otherwise associated with the upward movement of the storm curtain 11. Upon completion of the profiling sequence 200, the storm curtain 11 is movable between position limits as will be described. It should also be appreciated that in lieu of the profiling sequence 200, a mechanical switch or circuit jumper maintained by the control circuit 102 may be utilized to associate the rotational direction of the motor shaft 103 with the upward and downward movement of the storm curtain 11.

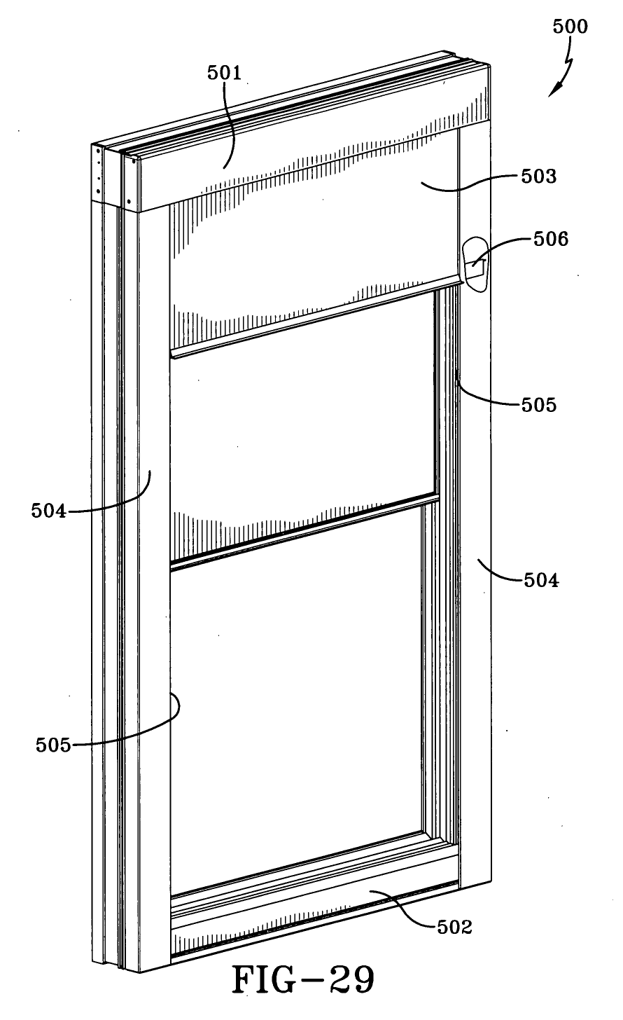

After the profiling sequence 200 has been performed, the motor assembly 95 is ready for service. As such, the operational steps taken by the motor assembly 95 during use are generally designated by the numeral 300, as shown in FIG. 28. In order to implement the operational steps, the control circuit may utilize various timers and software flags. The timers are primarily used to ensure that a locking function or a complete curtain move function has taken place. The timers, also referred to as timeout timers, are used to stop the motor if, for whatever reason, the control circuit does not sense a motor stall within an expected period of time. This is a basic form of error detection, but only minor error handling, such as stopping the motor are provided. Of course, more elaborate error handling procedures could be implemented and appropriate error signals could be distributed to an appropriate remote transmitter or receptive network module.

Initially, at step 310, the user sends an activation signal to the receiver 190 of the motor assembly 95 using the remote transmitter 192, or other suitable transmitting device such as the wall station previously discussed. It is also contemplated that the control circuit 102 may be a node that is part of suitable networking hardware and/or software enabling the activation signal to be communicated to the motor assembly 95 via a wireless or hardwired networked computing device. In any event, once the activation signal has been received by the motor assembly 95, the process 300 determines whether the storm curtain 11 is moving or not, as indicated at step 320. If the storm curtain 11 is moving, then the process 300 moves to step 330, where the motor assembly 95 stops the movement of the storm curtain 11 and the process returns to step 310. If the storm curtain 11 is not moving, then the process 300 continues to step 340. Thus it will be appreciated that the control logic operates in such a way that receipt of the activation signal causes the curtain to stop if moving, and move in a direction opposite the last direction of travel if not moving. In other words, the operating logic is open, stop, close, stop, and so on.

At step 340, the process 300 determines whether the last movement of the storm curtain 11 was in the upward direction or not by checking an appropriate direction indicator maintained by the control circuit 102. This could be in the form of a software flag maintained in memory or the like. Based on the outcome of this determination at step 340, the process 300 continues to step 350 if the last movement of the storm curtain 11 was not in an upward movement, or the process continues to step 360 if the last movement of the storm curtain 11 was in an upward movement. Assuming that the last movement of the storm curtain 11 was not in the upward direction, the process 300 moves to step 350 where a move timeout count value is periodically updated by the control circuit 102. The move timeout count may comprise any predetermined time period, such as sixty seconds for example. Somewhat simultaneously with the updating of the move timeout count, the motor assembly 95 moves the storm curtain 11 in an upward direction, as indicated at step 370. Next, while steps 350 and 370 are being performed, the control circuit 102 determines whether the motor 101 has an electrical current stall, or whether the timeout count has expired, as indicated at step 380. If the motor 101 has experienced an electrical current stall or if the timeout count has expired, then the upward movement of the storm curtain 11 is stopped, such that the curtain 11 is wound up into the exterior chamber 21 and has reached an upward limit position, as indicated at step 390. Once the storm curtain 11 has stopped, the motor assembly is stopped and the process 300 returns to step 310. However, if the motor 101 has not experienced an electrical current stall or the timeout count at step 380 has not expired, then the process 300 returns to step 370 and the curtain is moved upwardly.

Returning to step 340, if the last movement of the storm curtain 11 was in an upward direction, the process continues to step 360 where the control logic determines whether the storm curtain 11 is in a locked position as shown in FIG. 26F. The control logic maintains an appropriate variable or software flag indicating whether the curtain is in a locked or unlocked state. If the storm curtain 11 is in an unlocked position, which is whenever the curtain is not in a locked position, then the process 300 continues to step 400, where a Move timeout count value is updated by the control circuit 102. As previously discussed, the move timeout count may comprise a predetermined period of time, such as sixty seconds for example. Somewhat simultaneously with the updating of the move timeout count, the motor assembly 95 moves the storm curtain 11 downward, as indicated at step 410. Somewhat concurrently with steps 400 and 410, the control circuit 102 at step 420 monitors whether the motor 101 is drawing an increased amount of electrical current, or whether the timeout count initiated at step 400 has expired. If the motor 101 is not drawing an increased amount of electrical current, and if the move timeout count is not expired, process 300 returns to step 410. However, if motor 101 draws an increased amount of electrical current, or the move timeout count is exhausted, process 300 continues to step 430.

At step 430, the motor assembly 95 stops the movement of storm curtain 11 at its first resting position as shown in FIG. 23D, and the control circuit 102 updates a lock timeout count of another predetermined time period, somewhat shorter than the period of time set at step 400, such as ten seconds. Somewhat simultaneously with the updating of the lock timeout count, the control logic proceeds to step 432 and the motor assembly 95 moves the curtain 11 upwardly, corresponding with the movement shown in FIG. 26E. At step 434, the control logic determines whether a motor stall occurs or whether the timer set in step 430 times out. If neither event occurs, steps 432 and 434 continue to loop. However, once the motor assembly stalls (FIG. 26F), or the timer times out, the process continues to step 436 where the curtain variable is changed to a “locked” state, and motor assembly 95 is stopped at step 390. Thereafter the process returns to step 310. In the alternative, a more sensitive error handling procedure could be utilized. For example, if this process were used remotely and the process moved all the way to step 434, but never detected the current stall and the lock timer stopped, the control circuit logic would still think that the curtain is locked, when this might not be the case. A better error handling would be to attempt to close and lock again (up to 3-4 times) until it senses a current stall. So, in step 434, when the lock timer times-out, the process could return to step 410, as indicated by the dashed line 437, and repeat the lock process again. This could be done 3-4 times and if a current stall is still not obtained at step 434, the motor could be stopped with the curtain UNLOCKED and report an error to a network module or appropriate interface. Additionally, if a timeout in steps 380, 420 or 460 is detected, the motor could be stopped and reported as an error by the control circuit's logic. Failure at step 434 is the more critical error since someone could be attempting to lock the curtain remotely.

Returning to step 360 of the process—via steps 310, 320, and 340—if the storm curtain 11 is already in a locked position, as indicated by the curtain variable being in a locked state, the process 300 proceeds to step 440 where a lock timeout count value of a predetermined amount, such as 10 seconds for example, is periodically updated by the control circuit 102. Somewhat simultaneously with step 440, the storm curtain 11 is moved downward, as indicated at step 450 (shown in FIGS. 26G and 26H). Somewhat simultaneously with the execution of steps 440 and 450, step 460 is performed. At step 460, the process returns to step 450 if the control circuit 102 determines that the motor 101 is not drawing an increased electrical current, or if the timeout count has not expired. However, if the motor 101 draws an increased amount of electrical current or if the timeout count expires, the process continues to step 470. At step 470 the curtain variable is changed from “locked” to “unlocked” and the motor assembly 95 stops the movement of the storm curtain 11 at its second resting position, shown in FIG. 23I. The control circuit 102 now begins periodically updating a move timeout count value of a predetermined amount, such as 60 seconds for example. Next, somewhat simultaneously with step 470, the motor assembly 95 moves the storm curtain 11 in an upward direction at step 370 so as to open the storm curtain 11 (shown in FIGS. 26J and 26K). While step 370 is carried out, step 380 is performed as previously discussed. As such, if the process 300 determines that a motor stall has occurred, then the movement of the storm curtain 11 is stopped at step 390, where it has reached the open limit position.

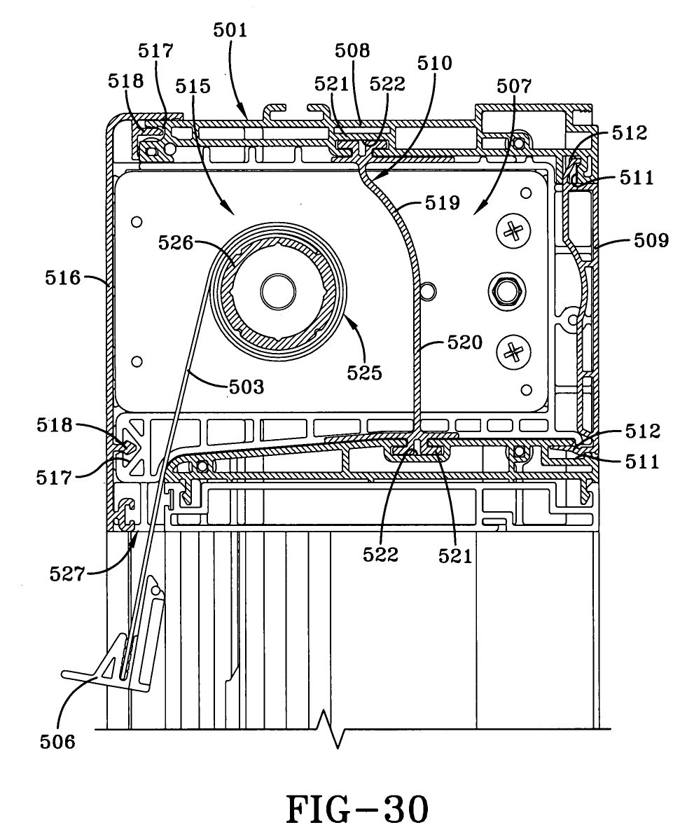

An alternate storm curtain assembly, generally indicated by the numeral 500 is n FIG. 29. Storm curtain assembly 500 is mounted in the surrounding framework of a building opening and may be integrated into the frame of a standard window. As in the first embodiment, assembly 500 includes a header unit 501 which is positioned proximate the top of the building opening. A locking sill 502 is positioned proximate the bottom of the building opening and is adapted to receive and selectively secure the bottom of a curtain 503 as will be hereinafter described in more detail. A pair of vertical tracks 504 extend between header unit 501 and locking sill 502 and provide channels 505 which guide a bar 506 and correspondingly curtain 503 as it is moved up and down.

Referring now to FIG. 30, header unit 501 includes a pair of separated chambers. An interior chamber 507 is defined by a housing 508, inner cover 509, and sealing wall generally indicated by the numeral 510. Housing 508 is secured to a building frame in any manner known in the art, and may include interior grooves or channels 511 which receive an extending lip 512 of inner cover 509. Inner cover 509 may thus be selectively secured to, and removed from housing 508 to provide access to interior chamber 507.

An exterior chamber 515 is defined by housing 508, sealing wall 510 and an outer cover 516. Housing 508 may include exterior grooves or channels 517 which receive an extending lip 518 of outer cover 516. Outer cover 516 may thus be selectively secured to, and removed from housing 508 to provide access to exterior chamber 515.

Sealing wall 510 is a contiguous wall that provides an environmental, moisture-resistant seal between interior chamber 507 and exterior chamber 515. Sealing wall 510 includes a generally curve upper portion 519 and a vertically oriented, generally straight lower portion 520. Sealing wall 510 may include longitudinal prongs 521 that are received in longitudinal slots 522 within housing 508. Sealing wall 510 may also be secured to housing 508 using other mechanical means, an adhesive, or may be integral therewith. Thus, if rain or debris penetrates into exterior chamber 515, sealing wall 510 prevents such materials from entering interior chamber 507. As a result of the inclusion of segregated chambers helps prevent water and wind from penetrating the interior of the building. Further, sealing wall 510 provides protection to sensitive drive components, some of which may include electronics, which may become inoperable if exposed to water or other debris.

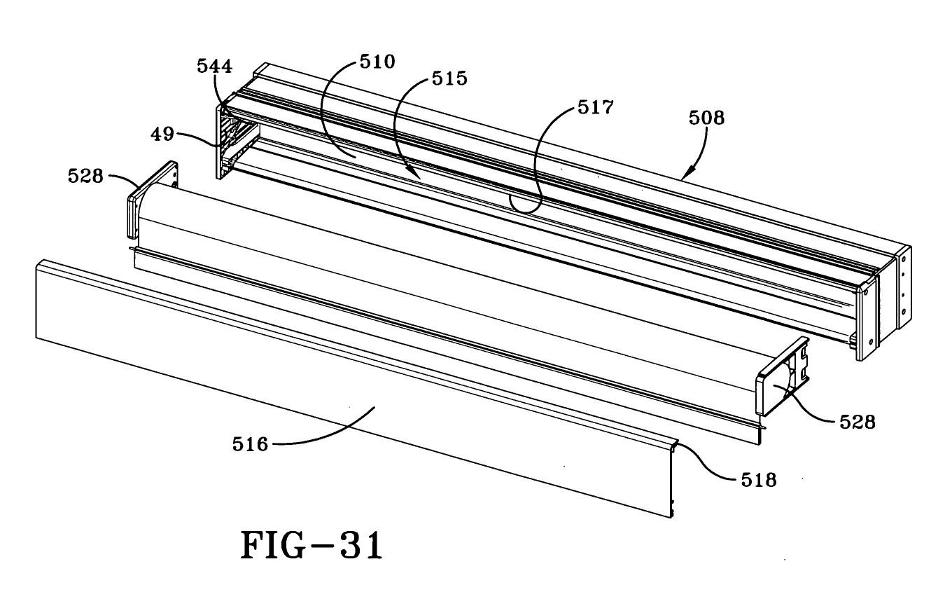

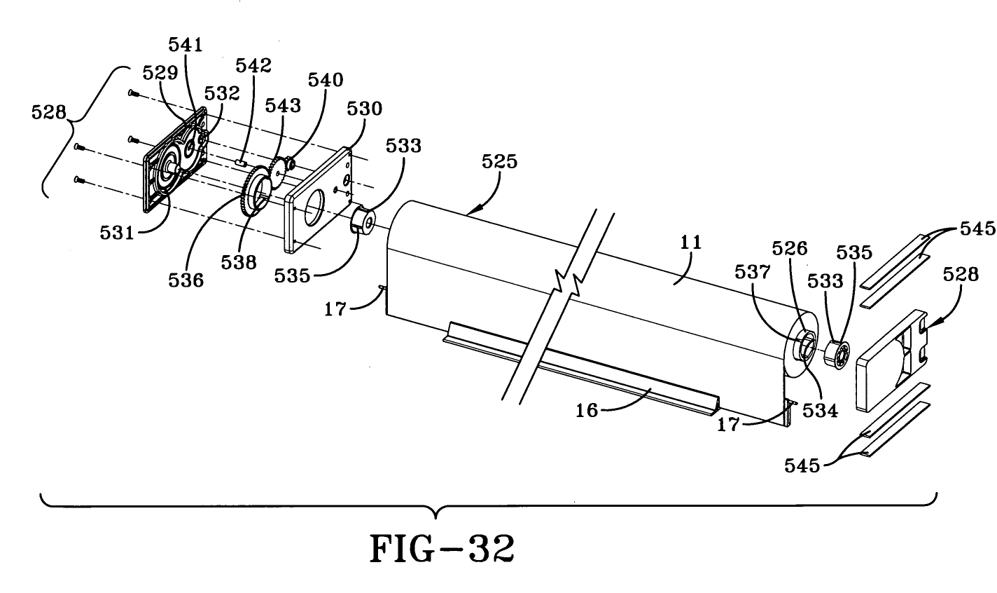

Exterior chamber 515 houses a storage roll assembly, generally indicated by the numeral 525, which carries curtain 503. Curtain 503 may be secured to a hollow shaft 526 at its upper end. A length of curtain 503 is wrapped around shaft 526 and exits exterior chamber 515 at an opening 527. As shown in FIGS. 31 and 32, shaft 526 is carried at each end by end supports 528. End supports 528 not only carry shaft 526, but also mechanically link shaft 526 to a rotational input mechanism (to be hereinafter described) located in interior chamber 507. End supports 528 are modular and each includes a first housing half 529 and an opposed second housing half 530. First housing half 529 includes an exterior spindle 531 and an interior spindle 532. Exterior spindle 531 receives a bearing 533 which is rotatable thereon. Bearings 533 are received by and secured to the interior ends of shaft 526. Rotational coupling is accomplished by the intermeshing of lateral grooves 534 on the interior of shaft 526 and ribs 535 on the exterior of bearings 533. A driven gear 536 is secured to the exterior of shaft 526 and rotatably coupled thereto by the intermeshing of lateral grooves 537 on the exterior of shaft 526 and ribs 538 on the interior of driven gear 536. The interior spindle 532 receives a drive gear 540 which is rotatable thereon. First housing half 529 also includes a pin hole 541 that securely receives a failsafe pin 542 therein. An intermediate gear 543 is received on and rotates about failsafe pin 542. When housing halves 529 and 530 are assembled, gears 536, 540, and 543 are enclosed therein. As is evident from FIG. 32, drive gear 540 and intermediate gear 543 are mechanically intermeshed so that, for example, clockwise rotation of drive gear 540 will cause corresponding counter-clockwise rotation of intermediate gear 543. Likewise, intermediate gear 543 and driven gear 536 are mechanically intermeshed so that, for example, counter-clockwise rotation of intermediate gear results in corresponding clockwise rotation of driven gear 536.

Shaft 526 is supported by, and coupled to, each driven gear 536 so that when driven gears 536 rotate, shaft 526 rotates therewith. Thus, shaft 526 is rotatable to draw curtain 503 upward or downward to selectively uncover or cover the building opening. Though the present embodiment does not disclose a counterbalance mechanism, it should be appreciated that the one could be included, and in particular could be of the design discussed in relation to the embodiment of FIG. 7. Counterbalance mechanisms may be particularly useful if the building opening is relatively large, requiring curtains of greater size and weight.

As shown in FIG. 31, sealing wall 510 does not extend completely to the side walls of housing 508. Rather, a support opening 544 is provided at each side of sealing wall 510. End supports 528 are received through support openings 544 and positioned so that driven gear 536 resides substantially in exterior chamber 515 and drive gear 540 resides in interior chamber 507.

End supports 528 are modular, and may be inserted and removed from support openings 544 for installation and/or servicing. One or more shims 545 (FIG. 32) may be provided above and below end supports 528 to ensure proper curtain alignment. Once storage roll assembly 525 and end supports 528 are installed, outer cover 516 may then be installed, with extending lip 518 being received in exterior groove 517. It should be evident that such a configuration allows easy disassembly and replacement of storm curtain parts.

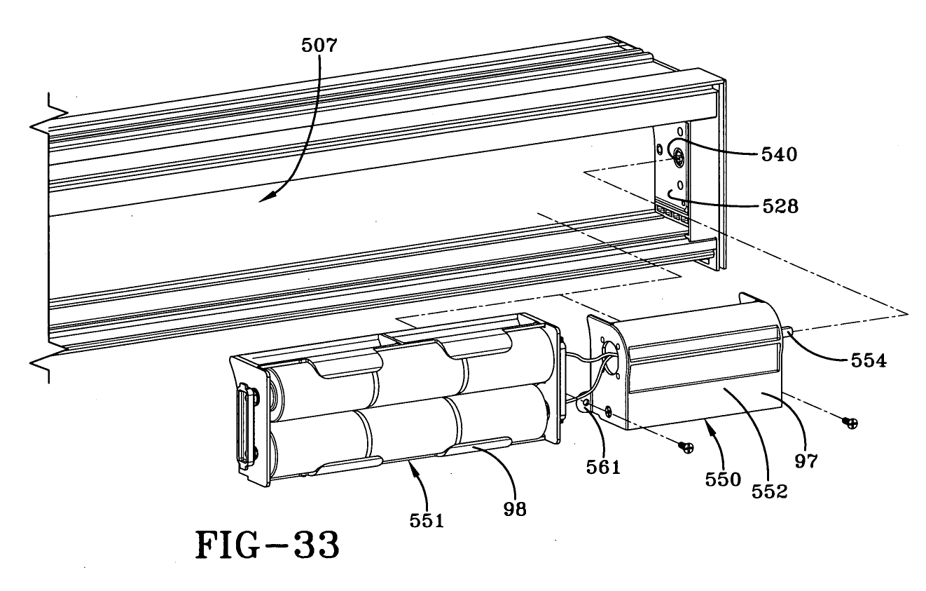

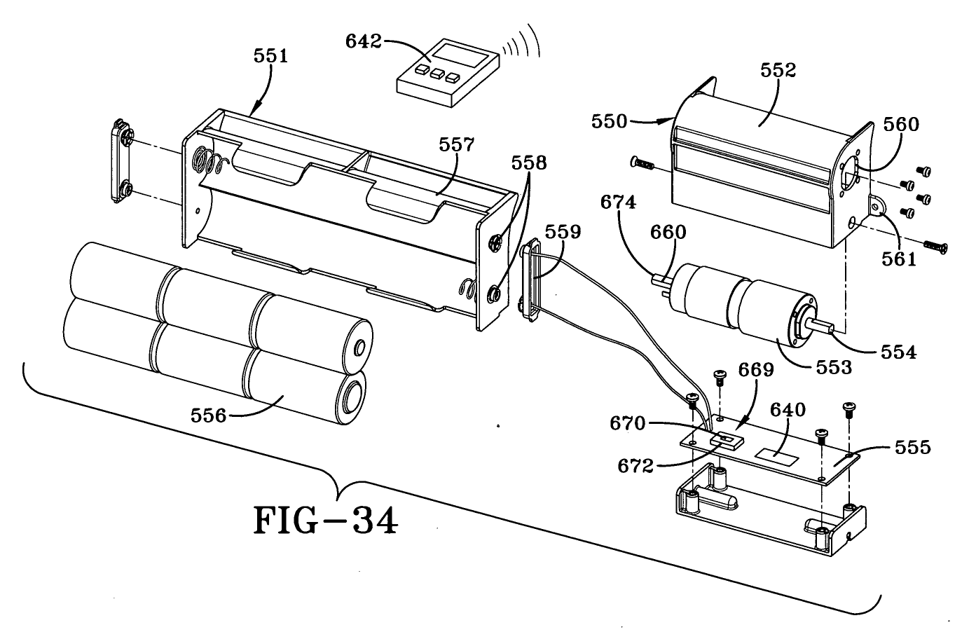

Referring now to FIG. 33, which shows the interior chamber 507 with inner cover 509 removed, it can be seen that each end support 528 extends into and is otherwise exposed to interior chamber 507. Drive gear 540 is thus exposed to interior chamber 507 and translates rotational inputs from interior chamber 507 to shaft 526 via intermediate gear 543 and driven gear 536. The input mechanism may be in the form of a motor assembly 550 and battery pack 551 that are secured within interior chamber 507. However, other input mechanisms are contemplated, for example, the rotational input mechanism may be in the form of a manually operated endless cord.

Motor assembly 550 includes an outer housing 552 that carries an electric motor 553. Though the present embodiment discloses a DC motor, other motor designs, including AC motors may be used. Motor 553 includes a drive shaft 554 that extends out of housing 552 and is adapted to rotationally couple to drive gear 540. To that end, drive gear 540 may include a central collar shaped to receive and engage drive shaft 554.

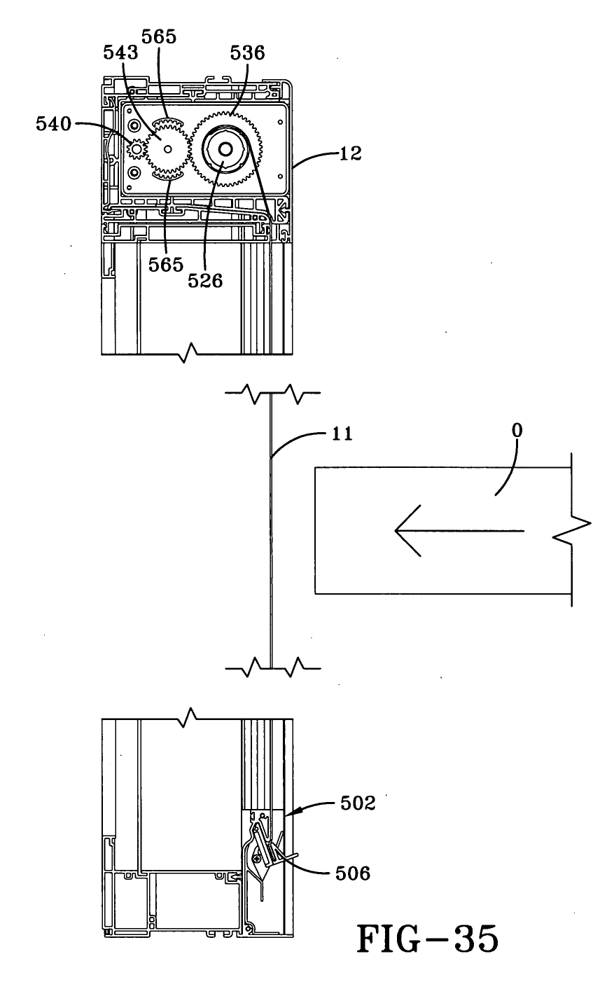

As shown in FIG. 34, a control circuit 555 maintained on a circuit board is carried within motor housing 552 and controls the operation of the motor 553, as well as various other aspects of the storm curtain assembly 500. Control circuit 555 includes the necessary hardware, software, and memory for carrying out the various functions of the storm curtain assembly 500. Indeed, the control circuit 555 may include a memory unit, which may comprise non-volatile memory, volatile memory, or a combination of both. In one aspect, the memory unit may be used to store the commands for a variety of operations that may be invoked to control the movement of the curtain 503. For example, the memory unit could store transmitter identification codes, identification codes that are part of a home appliance network as well as to various other data to be discussed herein below. Control circuit 555 may also include a variety of sensors, such as an electrical current sensor that is adapted to monitor electrical current draw of the motor 553, as well as sensors to monitor the movement and/or position of the shaft 554.

Power is supplied to the motor 553 and to the control circuit 555 by a plurality of batteries 556 carried within an outer housing 557 of battery pack 551. In the present embodiment, a pair of terminals 558 are provided at each end of battery pack 551 that are selectively attached to a power coupling 559 that in turn is connected to the control circuit 555. Terminals 558 are provided on both sides of battery pack 551 to enable motor assembly 550 to be coupled to drive gear 540 on either side of the header unit 501. To that end, a shaft opening 560 is provided on both sides of motor housing 552 so that motor 553 may be positioned within housing 552 to face either direction. Also, because battery pack 551 includes terminals 558 on either side, additional battery packs may be stacked in parallel and electrically coupled to terminals 558 of adjacent battery packs. In this manner, additional power can be provided to motor 553.

It should also be appreciated that both battery pack 551 and motor assembly 550 include rear profiles that, in end view, generally match the profile of sealing wall 510. In this manner, both motor assembly 550 and battery pack 551 are flush against sealing wall 510 and are thereafter retained in interior chamber 507 by inner cover 509. Motor assembly 550 may be further secured within interior chamber 507 by a screw (not shown) inserted through a tab 561 into sealing wall 510.

As with the embodiment disclosed in FIGS. 13-17, the motor assembly 550 and battery pack 551 are serviceable and installable from the interior of the building. This may be desirous when weather conditions make outside access difficult. Further, when storm curtains 503 are installed in elevated openings, as would be the case in multi-story buildings, accessing windows from the exterior may prove difficult and dangerous. The present invention eliminates this problem and provides easy access from the inside.

Normal curtain movement is accomplished by rotating drive gear 540 via the input mechanism. In the present embodiment, as previously discussed, drive shaft 554 rotates drive gear 540, which in turn translates rotational movement to intermediate gear 543 through the mechanical intermeshing of the respective gears. Intermediate gear 543 thereafter translates the rotational movement to driven gear 536 through the mechanical intermeshing of the respective gears. Likewise, because driven gear 536 is coupled to roller shaft 526, rotation of drive gear 540 causes rotation of shaft 526. Rotation of shaft 526 causes upward or downward movement of curtain 503, depending upon the direction of rotation. When the operator desires the building opening to be unobstructed, the operator, through motor assembly 550 or manual operation (not shown), causes shaft 526 to wind up substantially all of curtain 503 into exterior chamber 515. Likewise, when the operator desires the opening to be covered, curtain 503 is unwound until it is received in locking sill 502. In this manner, curtain 503 may selectively obstruct the building opening for privacy purposes, or to prevent solar heat gain. Curtain 503 may also be lowered and locked in locking sill 502 to prevent window penetration by wind borne objects as will be hereinafter discussed.

In a manner to be hereinafter described, locking sill 502 receives and selectively secures the curtain 503 via locking bar 506. Thus, when a high wind event occurs, such as a hurricane, curtain 503 may be lowered and locked in locking sill 502. Once locked, tension may be applied to curtain 503 by motor assembly 550. Curtain 503 can thus protect the building interior, and in addition, curtain 503 may be used during normal weather for sun blocking or privacy purposes.

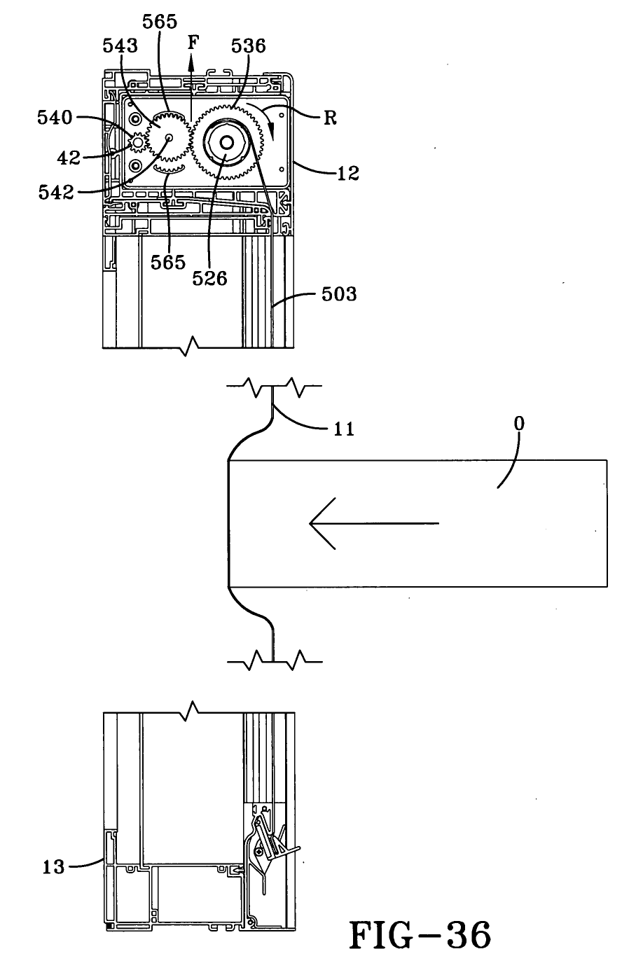

Referring now to FIG. 35, curtain 503 is shown as being secured to locking sill 502 in the tensioned condition. During high wind events, objects 0 may be carried by the wind and penetrate the opening if no protective membrane is provided. FIG. 36 shows object O after initially impacting curtain 11. In such a case, if the magnitude of impact is not too great, failsafe pin 542 will withstand the force and the motor assembly 550 will prevent gear rotation to maintain tension on curtain 503 which will repel the object O. The properly tensioned and locked curtain 503 also continues to prevent water penetration.

Failsafe pin 542 is designed to fail at a predetermined impact force. Failure is caused by the moment force applied by driven gear 540 upon impact from an object O. The moment force R (FIG. 36) results in an upward tangential force F on intermediate gear 543. Because intermediate gear 543 is prevented from rotation about failsafe pin 542 by motor assembly 550, a shearing force is applied to failsafe pin 542. If that force is greater than the shear strength of the failsafe pin 542, it will fail. The failure mechanism of failsafe pin 542 may be through shearing separation or deformation. That is, pin 542 may deform without actually severing the pin into two sections. In one or more embodiments, such deformation is permanent and, as will become apparent, such permanent deformation maintains the intermediate gear in a locked position. In other embodiments, pin 542 may actually sever into two pieces. In still other embodiments, failsafe pin 542 may elastically deform. Failsafe pin 542 may be designed to fail upon an impact on curtain 503 of 350 ft-lbs, which is about the force of a 2×4 piece of wood traveling at 50 ft/sec. The failure point of failsafe pin 542 may be modified by employing varying pin diameters and materials. In one or more embodiments, pin 542 may be composed of a plastic. In other embodiments, pin 542 may be composed of a metallic material.

In any event, upon failure of failsafe pin 542, the balance of forces will cause intermediate gear 543 to move upwardly to engage a toothed locking wall 565. As can be seen in FIG. 36, the teeth of intermediate gear 543 engage the teeth of locking wall 565 to prevent rotation. In so doing, shaft 526 is only allowed to rotate a small amount before further rotation is prevented by locking wall 565. As a result, tension on curtain 513 is maintained.

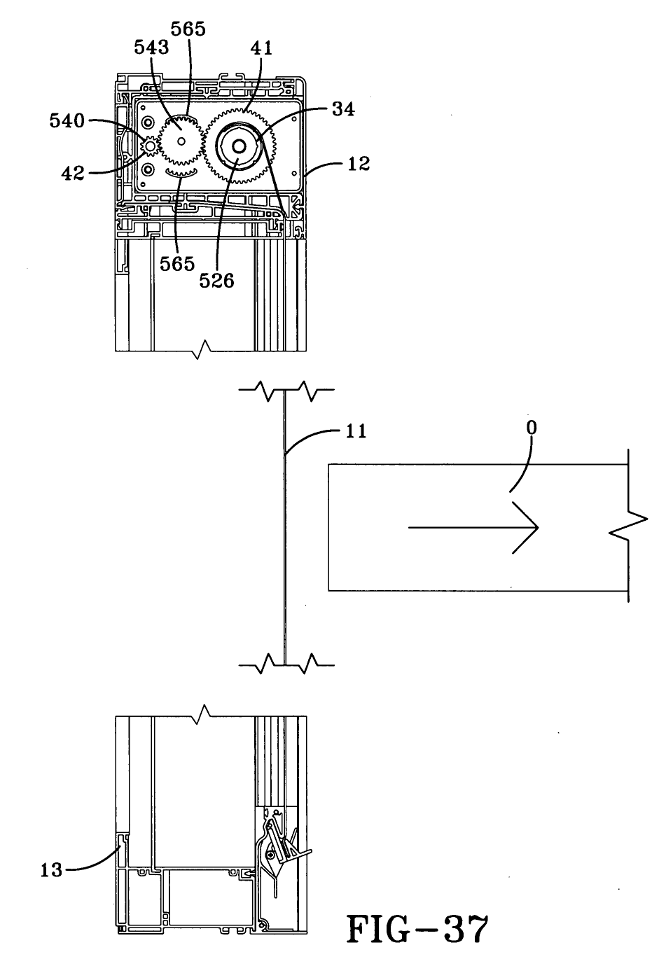

Referring now to FIG. 37, with the shaft 526 locked, the resilient quality of curtain 503 repels object O and building integrity is maintained. It has further been found that the volume of air contained between curtain 503 and the window acts as a buffer or spring, and compresses and absorbs some of the force of the impact. In this manner, storm curtain assembly 500 prevents building penetration of air, debris and air pressure change to the structure. Further, the motor and other drive mechanisms are protected by design of shear pin 542. Specifically, if high impact forces are realized against curtain 503, pin 542 fails and the impact force is absorbed by locking wall 565. Another locking wall 565 may be provided below intermediate gear 543 so that even if curtain 503 is paid out from the opposite side of shaft 526, impact protection is achieved. Of course, if pin 542 fails, the curtain 503 will remain locked pin 542 may be replaced. In this manner the relatively inexpensive pin is designed to fail in order to protect the home interior and structure, as well as other more expensive components of the curtain assembly.

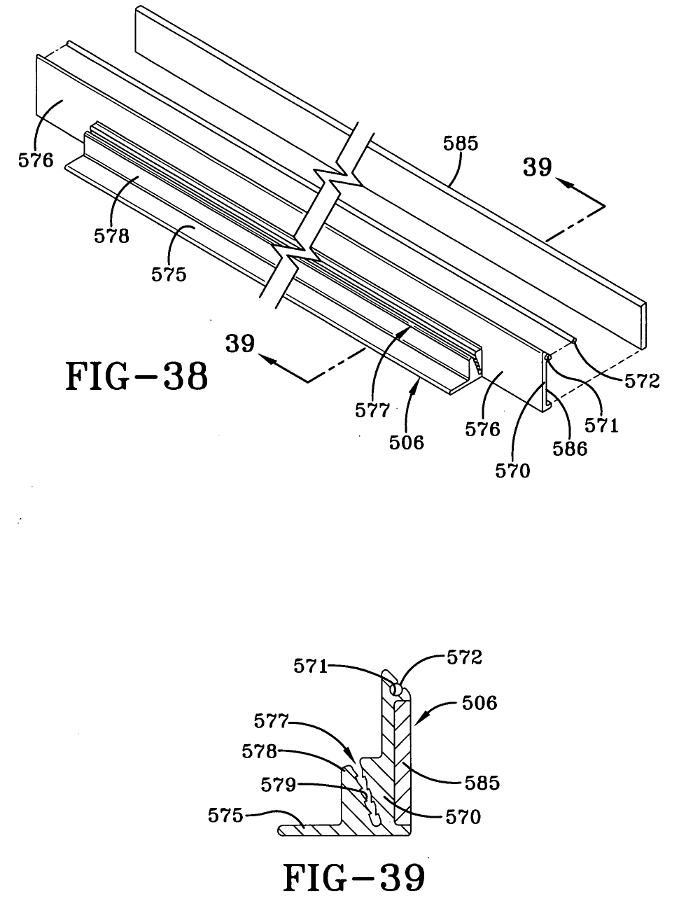

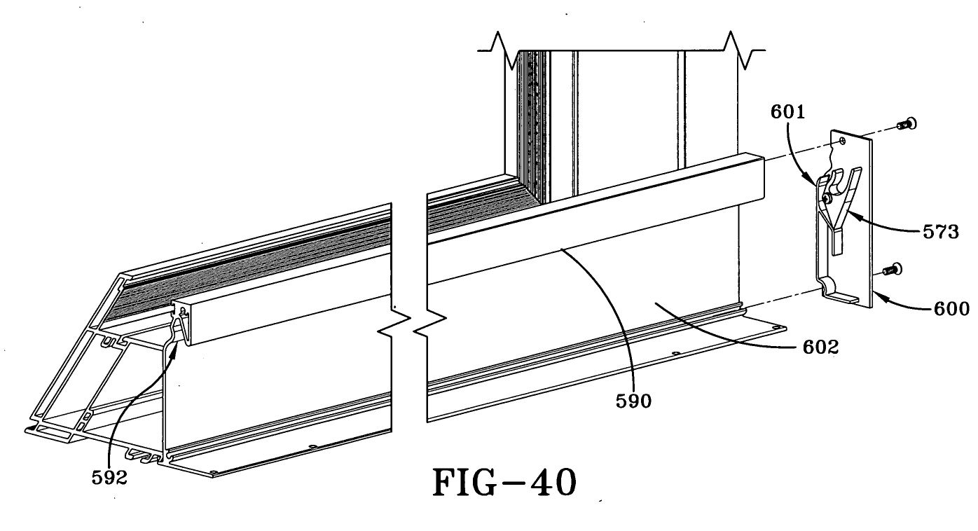

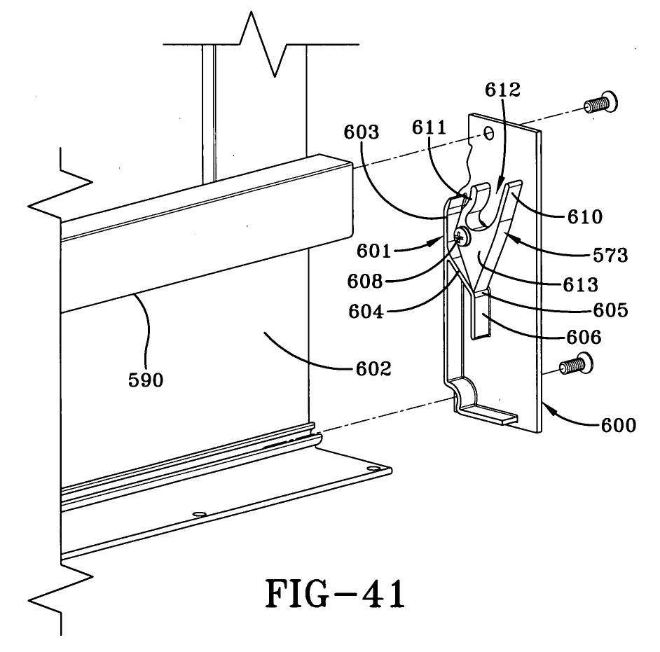

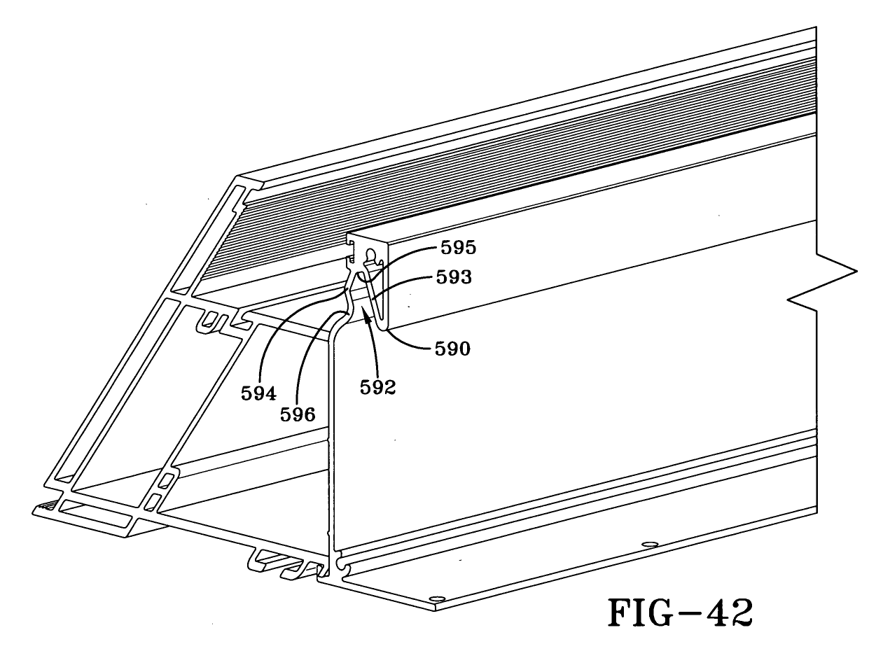

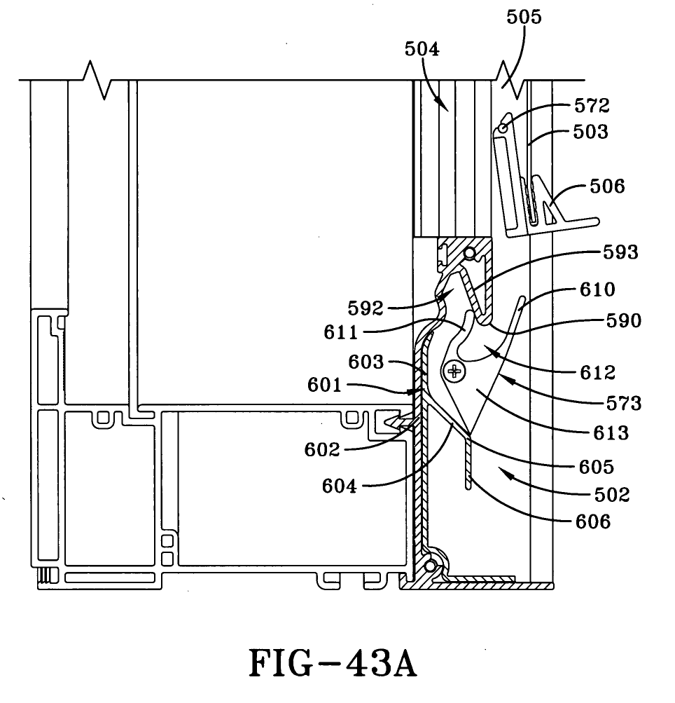

Referring now to FIGS. 38-42, an additional manner in which the curtain 503 is locked to sill 502 is shown. As previously discussed, vertical channels 505 are formed along the length of each vertical track 504 and extend from the area of header unit 501 downwardly to the bottom of sill 502. Vertical channels 505 are sufficiently wide to allow locking bar 506 to be oriented at an angle, preventing binding and rattling when curtain 503 is moved up or down.

Locking bar 506 includes a body 570 that is generally L-shaped in end view, and extends the length of the bottom sill 502 and into vertical tracks 504. A channel 571 extends longitudinally along the top of body 570 and is adapted to receive a pin 572 therein. In one or more embodiments pin 572 maybe a continuous metal pin extending from one longitudinal edge of body 570 to the other. In other embodiments, one pin may be provided at each longitudinal edge of body 570. In either event, pin 572 extends outwardly from each longitudinal end of channel 571 to engage a derailleur 573 as will be hereinafter described in more detail. Pin 572 may be crimped into place within channel 571.

Locking bar 506 further includes a grip portion 575 that extends generally perpendicularly from body 570 and provides a surface that a user may grasp in order to manually operate the curtain 503, if desired. Further, grip portion 575 adds strength to locking bar 506 assisting it in its ability to withstand high wind-load conditions. As is evident from FIG. 38, grip portion 575 does not extend all the way to the opposed longitudinal ends of body 570 and instead ends just before vertical track 504, with end portions 576 of body 570 extending therein.

Locking bar 506 further includes a clamp channel 577 that is adapted to receive and retain the bottom edge of curtain 503. One longitudinal side of clamp channel 577 is formed by body 570 and the other is formed by a longitudinal projection 578 extending upwardly from grip portion 575. The inner surface of clamp channel 577 includes a plurality of ribs or barbs 579 such that when crimped barbs 579 engage and retain curtain 503 within clamp channel 577.

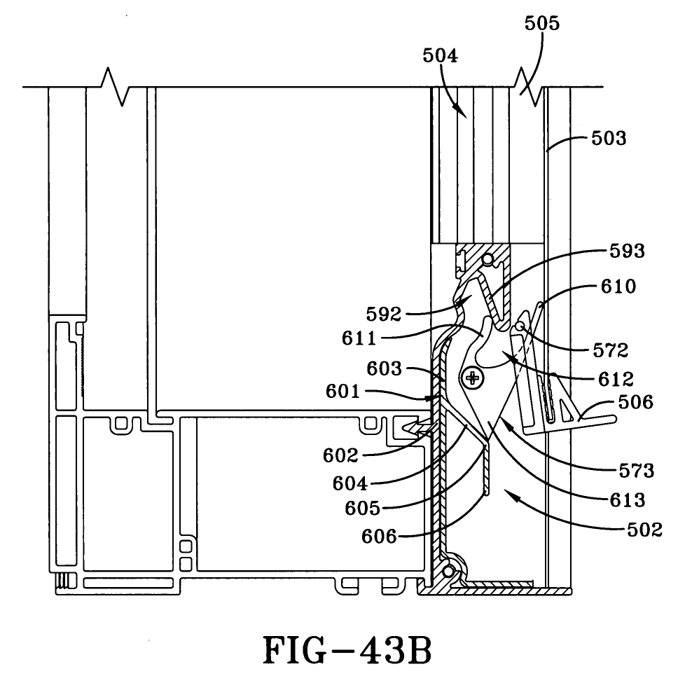

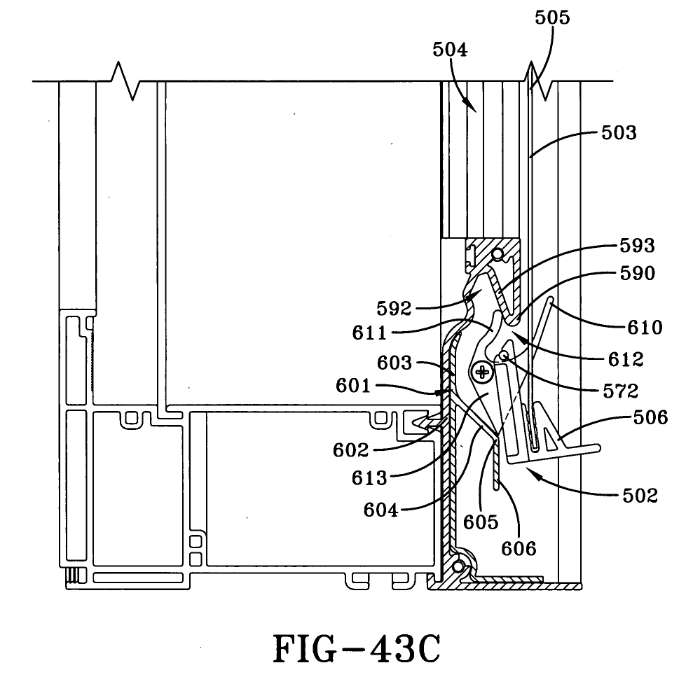

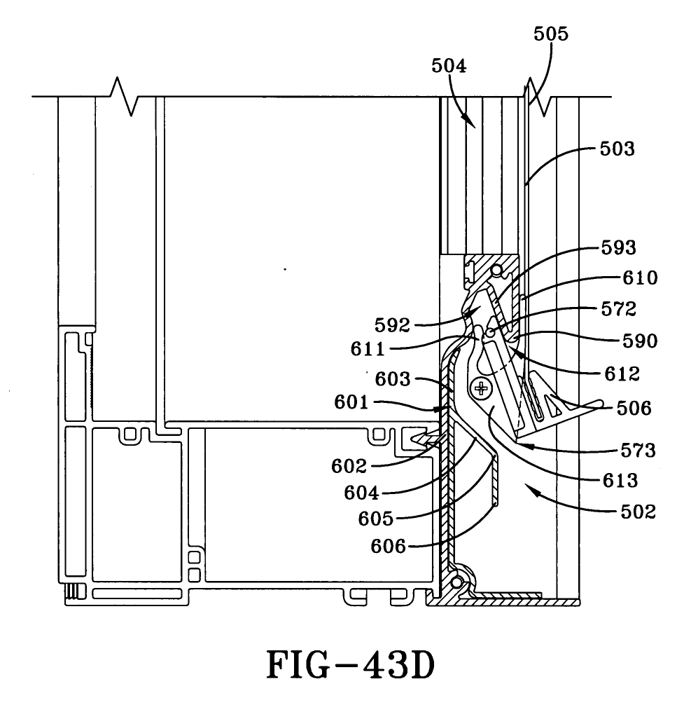

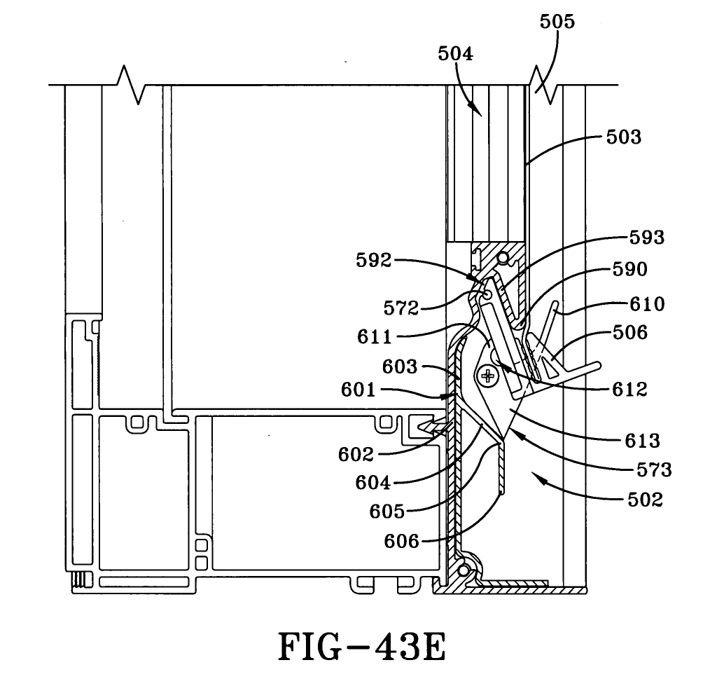

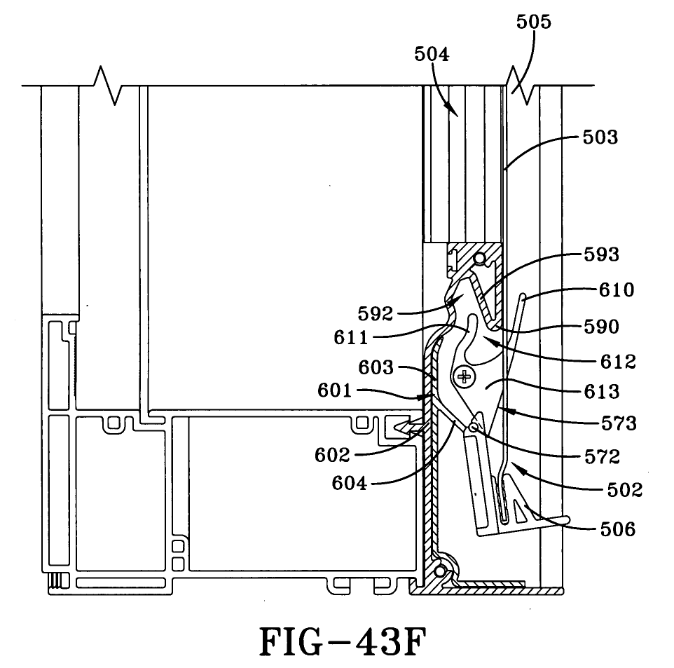

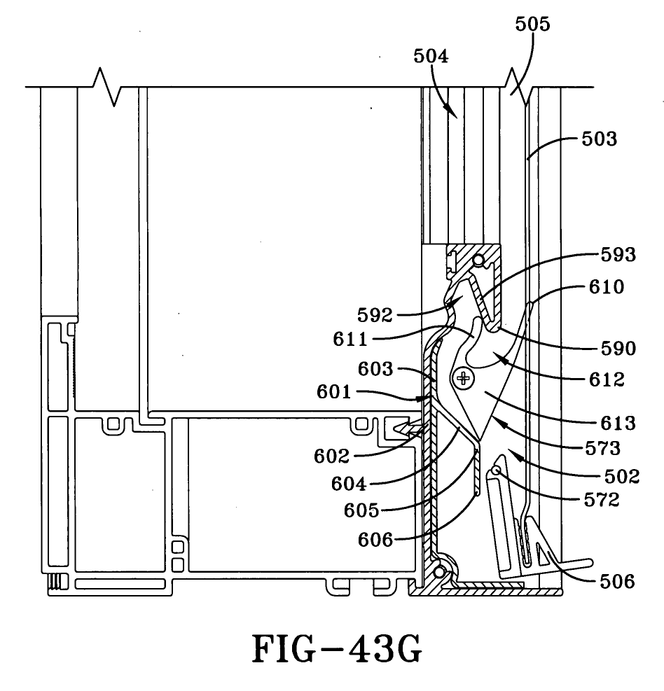

Similar to the locking bar 16, body 570 of bar 506 is biased and will tend to rotate in the counter-clockwise direction as shown in FIG. 43A. In one or more embodiments, the equilibrium orientation of body 570 is at 20 degrees relative to vertical channel 505. If additional weight is desired for smoother operation or for additional biasing, an insert 585 may be secured within an insert groove 586. Insert 585 may be made of any material of appreciable weight and may be adhered or mechanically fastened to body 570.

A locking channel 592 is formed along nearly the entire lateral length of the bottom lip 590 of sill 502 and extends into vertical tracks 504. Channel 592 is formed with a side wall 593 spaced from a side wall 594 by an end wall 595. Side wall 593 thus extends from lip 590 to end wall 595, and side wall 594 extends from end wall 595 to a lip 596. As is evident from FIG. 43A, locking channel 592 is disposed at an angle relative to vertical channel 505. In one or more embodiments locking channel is disposed at a twenty degree angle relative to vertical channel 505.

A derailleur insert 600 is positioned on opposed ends of the bottom sill 502. Each insert 600 includes a guide wall 601, a portion of which lies flush against a rear wall 602 of bottom sill 502 that extends downwardly from lip 596. Guide wall 601 includes a generally vertical portion 603 which extends downwardly along rear wall 602. An angled portion 604 extends from vertical portion 603 and terminates at a lip 605, and a second vertical portion 606 extends downwardly from lip 605.

Derailleur 573 is secured to derailleur insert 600 by a fastener 608 in a manner that allows pivotal movement thereof. Derailleur 573 is generally prong shaped and includes a first leg 610 and a second leg 611 that form a pin receiving channel 612 therebetween. Derailleur 573 further includes a wedge shaped leg 613 that extends downwardly on the opposed end from first and second legs 610 and 611.

As shown in FIG. 43A, because the majority of the weight of derailleur 573 is to the right of fastener 608, derailleur 573 is biased by gravity to rotate clockwise. However, rotation is prevented because leg 613 rests against angled portion 604 and/or leg 611 rests against side wall 593. It should be appreciated that other means, such as springs, may be employed to bias derailleur 573.

The manner in which locking bar 506 is utilized to lock curtain 503 across sill 502 is best shown with reference to the sequential views 43A-G. As shown in FIG. 43A, as curtain 503 moves downwardly, bar 506 moves down channel 505, and as it moves past lip 590, pins 572, which extend laterally outward from bar 506, are directed into pin receiving channel 612 of derailleur 573 (FIG. 43B and 43C). At this point, the curved surface of first leg 610 causes the top edge of bar 506 to pivot toward lock channel 592. This pivoting motion is further aided by bias of bar 506, which naturally wants to pivot toward locking channel 592. Downward movement of curtain 503 is terminated at a first resting position when pin 572 bottoms out in the pin receiving channel 612 (FIG. 43C). At this point, because pin 672 rests on derailleur 573, the weight of the bar is removed from curtain 503. The current draw of the operating motor may be monitored and the removal of the weight of bar 506 can be sensed. The change in current draw indicates the need to reverse the direction of curtain 503.

Upon reversal of the curtain direction (that is, upward), bar 506 is pulled upward into locking channel 592 (FIG. 43D). As it does so, pin 572 contacts second leg 611 of derailleur 573 and causes derailleur 573 to pivot counter-clockwise. In this manner, pin 572 moves upwardly between second leg 611 and side wall 593. It should be appreciated that, after pin 572 passes second leg 611, derailleur 573 will pivot back to its original position with wedge shaped leg 613 contacting angled wall 604. Bar 506 continues upward until a locked position is achieved and bar 506 contacts end wall 595 (FIG. 43E). At this point additional tension may be applied to curtain 503 to remove any slack or wrinkles therefrom. Once in locked position, the storm curtain assembly is prepared for high wind conditions.

When a user wishes to unlock curtain 503, the curtain direction is again reversed (that is, lowered) and bar 506 is allowed to move downwardly. Because second leg 611 of derailleur 573 is resting against side wall 593, pin 572 will now pass between second leg 611 of derailleur 573 and side wall 594 of locking channel 592. As bar 506 moves downward, pin 572 slides along angled wall 604 until it contacts leg 613 and forces derailleur 573 to again pivot counter-clockwise (FIG. 43F). In this manner pin 572 is allowed to pass between leg 613 and angled portion 604. After clearing the leg 613, the weight of derailleur 573 will again cause it to pivot clockwise into its resting position with second leg 611 resting against side wall 593. Bar 506 finally bottoms out at a second resting position at the bottom wall of sill 502 (FIG. 43G). At this point, the weight of the bar is again removed from curtain 503. The current draw of the operating motor may be monitored and the removal of the weight of bar 506 can be sensed. The change in current draw is thus indicative of the need to reverse the direction of curtain 503.

Upon reversal of the curtain direction, bar 506 is pulled upwardly. The natural tendency of bar 506 to pivot forward is now prevented by leg 613 of derailleur 573 which contacts pin 572 and prevents bar 506 from returning to the locking channel 592. As bar 506 continues to move upward, pin 572 slides along leg 613 and continues on to first leg 610. The weight of bar 506 against leg 610 causes derailleur 573 to pivot counter-clockwise and thereafter leg 610 prevents pin from entering pin receiving channel 612. This prevents a repeated locking cycle and instead holds derailleur 573 in a substantially upright position until it again enters channel 505. In this manner repeated and dependable locking and unlocking cycles may be achieved.

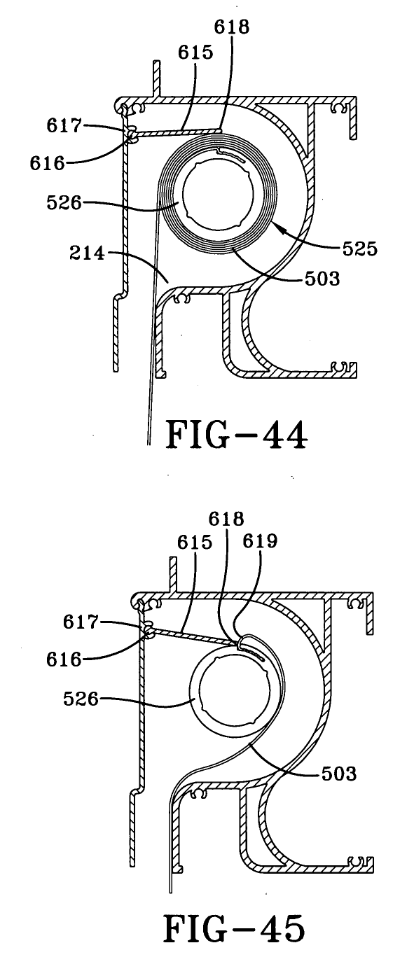

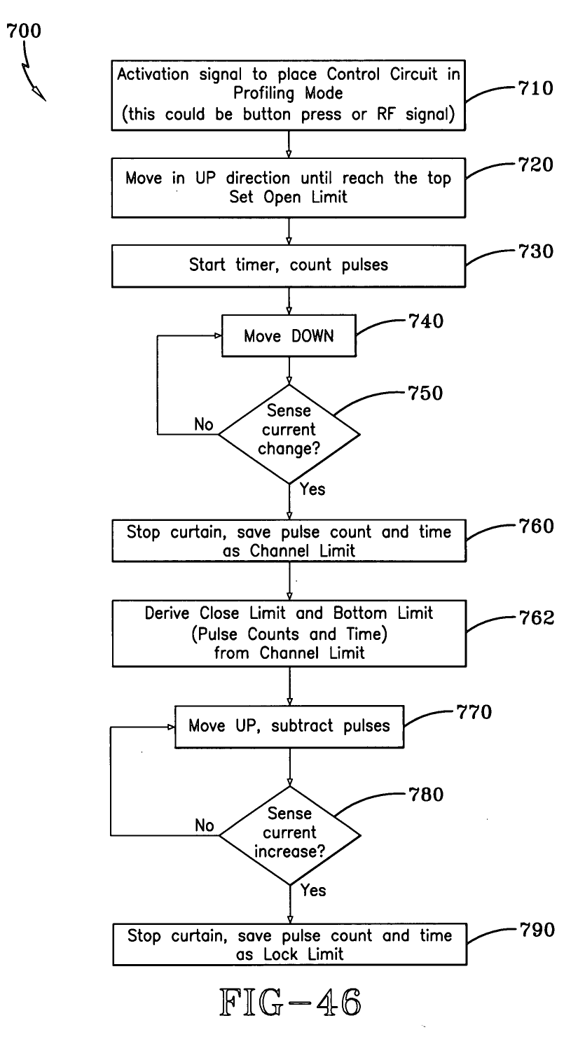

Referring now to FIG. 44 and 45, in one or more embodiments, a stop 615 may be used in conjunction with storage roll assembly 525. Stop 615 may be in the form of elongated plate and includes a circular or cylindrical end 616 pivotally received in a catch 617. Counter-clockwise rotation of shaft 526 will cause curtain 503 to unwind therefrom and stop 615 rides along the top of storage roll assembly 525 while curtain 503 is drawn into and paid out of header unit 502. As shown in FIG. 45, if curtain 503 is completely unwound from shaft 526, continued counter-clockwise rotation will cause curtain 503 to begin counter-winding in the opposite direction. This is allowed to occur for approximately one half of a turn, at which time the tip 618 of stop 615 engages the upturned edge 619 of curtain 503. Further rotation is thereafter prevented by stop 615. It should of course be appreciated that stop 615 may engage something other than the edge of curtain 503. For example, shaft 526 may include a notch on the surface thereof that may engage stop 615 upon exposure of the notched exterior surface of shaft 526. Such a stop feature may be useful to prevent inadvertent counter-rollup when assembly 500 is being manually operated. Further, stop 615 may be useful when assembly 525 is operated by motor assembly 550. For example, instead of sensing when the weight of bar 506 is removed from curtain 503, as in the first resting point (FIG. 43C) or second resting point (FIG. 436) during downward curtain movement, motor 553 may run until it stalls (when stop 615 engages upturned edge 619). In this manner, all directional changes are preceded by a motor stall condition.

To initiate the movement of the curtain 503 in either of an upward or a downward direction by the motor assembly 550, the control circuit 555 of the storm curtain assembly 500 includes a receiver 640, as shown in FIG. 34. The receiver 640 is configured to be responsive to various wired or wireless command signals, such as an up/down command or related command, sent from a suitable remote transmitter 642 capable of generating the appropriate signals upon an appropriate button actuation. Transmitter 642 may be provided with any number of command buttons. Actuation of these buttons, either singly or in combination, may be used to generate command signals that control movement of the curtain. By way of example, the command signals may be referred to as “Close,” “Lock,” “Open,” or “Stop,” to name just a few. The transmitter may also be provided with a display to show a status or position of the curtain or other relevant information. It is also contemplated that the control circuit 555 may be a node that is part of suitable networking hardware and/or software enabling a command signal as described above to be communicated to the motor assembly 550 via a wireless or hardwired networked computing device.

Furthermore, to monitor the movement of the curtain 503 during the various operational modes of the storm curtain assembly 500, an encoding indicia 660, along with an optical sensor 669 that provides a counting emitter 670 and a counting receiver 672 can be utilized, as shown in FIG. 34. The optical sensor 669 is part of the control circuit 555. The encoding indicia 660 is disposed about an encoding shaft 674 that is coaxial with, and attached to the drive shaft 554 of the motor 553. In one embodiment, the encoding indicia 660 may comprise a predetermined number of opaque non-reflective spaced marks to distinguish the reflective surface of the encoding shaft 674. In another embodiment, shaft 674 may be non-reflective and have reflective marks disposed thereon. In any event, the counting emitter 670 is configured to generate a light beam or other signal that is reflected by the encoding shaft 674 and received by the counting receiver 672. That is, as the encoder shaft 674 rotates, the light beam is periodically reflected due to the alternating opaque surfaces of the encoding indicia 660 and the reflective surfaces of the encoder shaft 674, so as to generate a series of light pulses that are received by the counting receiver 672. The detected light pulses, as well as their corresponding timing sequence, are then used to generate a count signal that is communicated to the control circuit 555. The count signal may be used in various manners, such as to determine if the curtain 503 is moving upward or downward, for example. It should also be appreciated that the control circuit 555 may include a timer to time the various upward and downward movements of the curtain 503. Skilled artisans will appreciate that other types of sensor configurations could be used to determine direction and/or position of the curtain. Such sensors could be in the form of a slotted encoder wheel, magnets, a Hall Effect sensor, and the like.

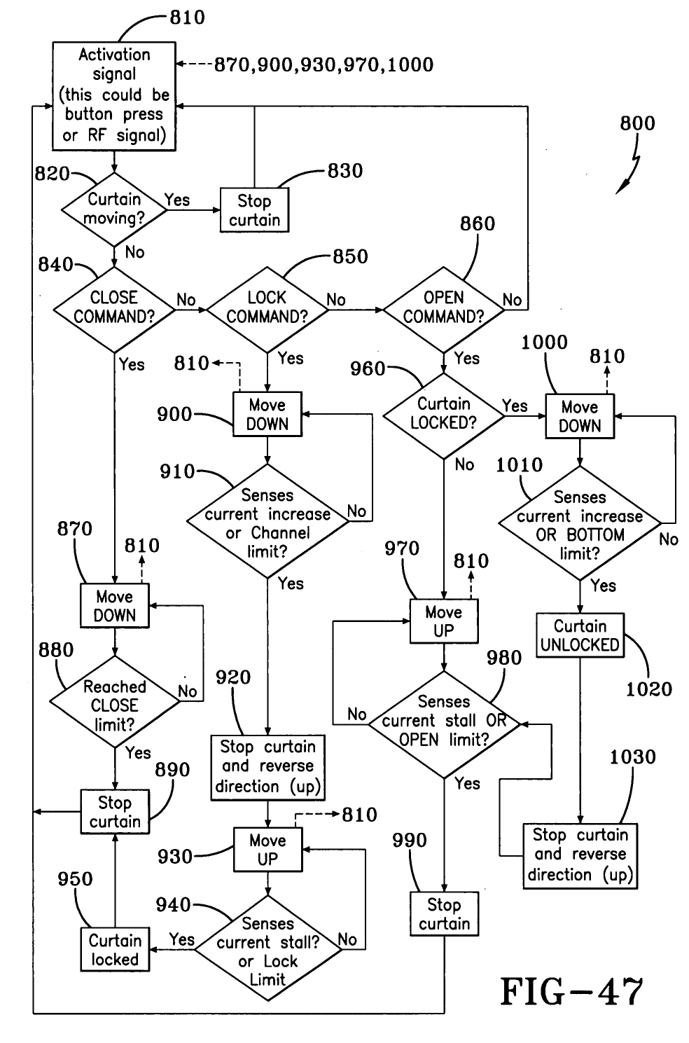

The operational process steps to profile or to otherwise identify the length of the curtain 503 and to determine where the stall points are located when the curtain 503 is first placed into service are generally referred to by the numeral 700, as shown in FIG. 46 of the drawings. It should be appreciated that the logic and memory necessary for carrying out the steps to be described may be provided in hardware, software, or a combination of both maintained by the control circuit 555.

Initially, at step 710 of the process 700, the user sends an activation signal via the remote transmitter 642 manual button activation or otherwise, to the receiver 640 so as to place the control circuit 555 into a profiling mode. Next at step 720, the motor 553 moves the curtain 503 upward until such time that the motor stalls. This is typically determined by control circuit 555 sensing an increased draw in current by the motor as an indication of stopped movement from counting receiver 672. Accordingly, an increased draw in motor current could be considered a parameter value. Other parameters, such as a detected tension or force or other sensor-detected value, could be used as a parameter value. In any event, this position is set by the control circuit as the OPEN limit position. The OPEN limit position may correspond to a curtain orientation wherein curtain 503 does not obstruct the window opening and bar 506 engages or otherwise is impeded by header 501. Next, the timer, the counting emitter 670 and the counting receiver 672 maintained by the control circuit 555 are initiated, as indicated at step 730. It should be appreciated that the timer and the counting emitter and receiver 670,672 allow the control circuit 555 to determine the distance that the curtain 503 moves during any given downward or upward movement thereof. Timer values and count values, or other comparably sensed variables, maintained by the control circuit 555 may be referred to as barrier position limit values which are used to establish travel limit positions and positions of the curtain or barrier with respect to the travel limit positions. Somewhat simultaneously with the initiation of the timer and counting emitter and receiver 670,672, at step 730, the curtain 503 is moved downward, as indicated at step 740. As this occurs, the pulses are counted and stored for later reference. At step 750, the control circuit 555 continuously monitors the electrical current drawn by the motor 553 as the curtain 503 is moved downward. If the electrical current consumed by the motor 553 does not noticeably vary, then the process 700 returns to step 740, allowing the curtain 503 to continue to move downward. However, if the control circuit detects that the electrical current drawn by the motor 553 noticeably changes, then the process 700 proceeds to step 760. At step 760, it is presumed that the curtain has reached the CHANNEL limit of travel and the motor 553 is deactivated, so as to stop the movement of the curtain 503. The bottom limit of travel may correspond to the first rest position shown in FIG. 43C. At this time, the number of pulses detected by the counting receiver 672 and the amount of time determined by the timer are stored in the memory maintained by the control circuit 555, so as to define a CHANNEL limit. Next, at step 762, the control circuit 555 derives or calculates a CLOSE Limit position from the CHANNEL limit position. The derivation is pre-programmed into the control circuit based upon the window's construction. Essentially, the count value and/or timer value that designates the CHANNEL limit is reduced a predetermined amount to obtain the CLOSE limit. Accordingly, once the curtain travels downwardly past the CLOSE limit position, the curtain must travel through the first rest position and the bar locked position before it can return to anywhere between the OPEN and CLOSE limits. Also at step 762, control circuit 555 derives or calculates a BOTTOM limit position from the CHANNEL limit position and/or the CLOSE limit position. The derivation is pre-programmed into the control circuit based upon the window's construction. Essentially, the count value and/or timer value that designates the CHANNEL limit is increased a predetermined amount. Alternately, the BOTTOM limit may be physically sensed in the same manner as the CHANNEL when bar 506 reaches the second resting position, shown in FIG. 43G.

At step 770, the control circuit 555 initiates the upward movement of the curtain 503. As the curtain 503 moves upward, the counting receiver 672 detects the pulses generated by the rotating encoding shaft 674, which are then subtracted from the total number of pulses collected during the downward movement of the curtain 503 at step 740. Additionally, the timer is initiated to ascertain how long it takes the curtain 503 to reach its LOCK limit. The lock limit may correspond to the bar locked position shown in FIG. 43E. As the curtain moves up at step 780, control circuit 555 continually monitors the motor to determine whether there has been an increase in electrical current drawn. If there has not been an increase in electrical current consumed by the motor 553, then the process returns to step 770, whereby the curtain 503 continues to be moved upward. However, if there has been an increase in electrical current consumed by the motor 553 at step 780, then the process 700 continues to step 790. At step 790, the control circuit 555 stops the movement of the curtain 503, and the updated pulse count and time are stored as a LOCK limit in the memory of the control circuit 555. The pulse count and the time associated therewith define the LOCK limit position of the curtain 503.

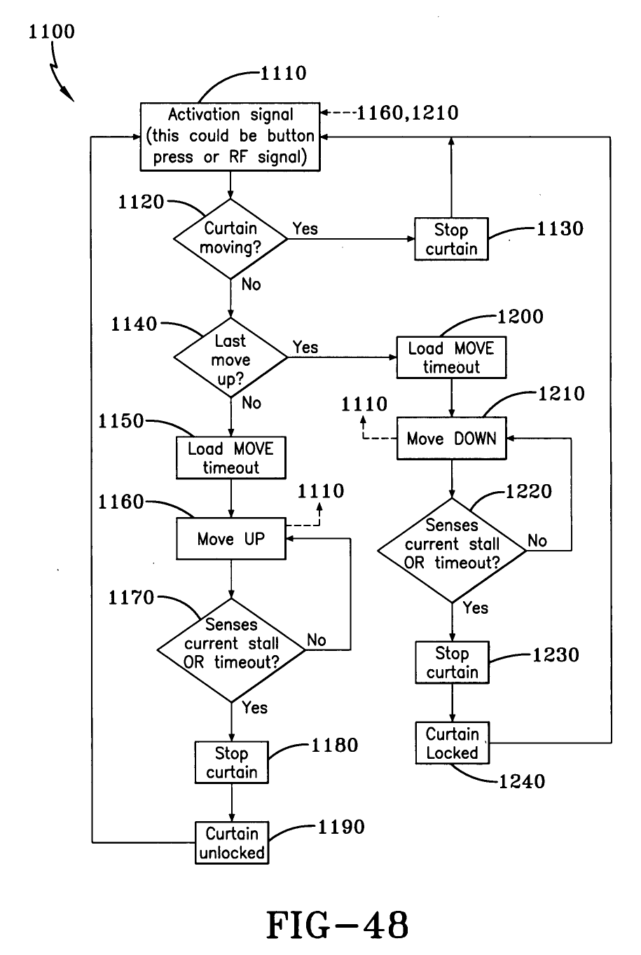

Once the storm curtain 503 has been profiled, as discussed above with regard to the process 700, the storm curtain assembly 500 may be put into service. Specifically, the operation of the storm curtain assembly 500 is controlled by the control circuit 555 in accordance with the operational steps generally referred to by the numeral 800, shown in FIG. 47. Generally, the control circuit 555 can use either the time of curtain travel or a pulse count learned during the profile procedure to determine whether a limit position has been reached or not. In some embodiments, the control circuit 555 could be configured to use both time of travel and pulse counts to determine curtain position and when a limit position has been reached. In other words, one of the parameters could be used to confirm that the other is in fact at a value associated with the expected position. It will further be appreciated that the curtain travels between up to five limit positions—OPEN, CLOSE, CHANNEL, LOCK and BOTTOM. The LOCK limit position may be considered to be between the OPEN and CLOSE limit positions. In other words, the LOCK limit position is a position that is reached or attained from one of the other limit positions. As such, once the curtain is at the CHANNEL limit position it must proceed or travel to the LOCK limit position, and then to the BOTTOM limit position before the curtain can travel toward the OPEN limit position. In most embodiments, the curtain, when in a LOCK limit position, is relatively positioned between the OPEN and CHANNEL limit positions. But as will be appreciated, the LOCK limit position is only reached in the curtain's path of travel after first being in the CHANNEL limit position. And in the present embodiment, the LOCK limit position is reached only after the CLOSE limit position has been attained, but it is conceivable that in other embodiments the LOCK limit position could be reached from the OPEN limit position if the curtain locking configuration is re-arranged.

At step 810, the user sends an activation signal, which may be any type of command signal, via the remote transmitter 642 or otherwise, to the receiver 640, so as to cause the curtain 503 to move to one of a CLOSE, LOCK, or OPEN limit position. Next, at step 820, the process 800 determines whether the curtain 503 is already moving or not. If the curtain 503 is already moving, then the process 800 continues to step 830 where the movement of the curtain is stopped, and the process returns to step 810. In other words, any command signal received during movement of the curtain overrides the previously received command signal. This allows the user to selectively position the curtain anywhere between the limit positions. In any event, if the curtain 503 is not moving at step 820, then the process continues to step 840, where the process determines whether a close command has been received at the receiver 640. If a close command has not been received, then the process 800 continues to step 850, to determine whether a lock command has been received or not. If a lock command has not been received at step 850, then the process 800 determines whether an open command has been received or not at step 860. If neither of a close command, lock command, or an open command is received at respective steps 840, 850, 860, then the process 800 returns to step 810. Thus, from a stopped condition the process 800 scans through the possible commands to determine which one has been initiated at the transmitter 642.

Returning to step 840, if a close command has been received by the control circuit 555, then the process 800 continues to step 870. At step 870, the motor 553 moves the curtain 503 downward, while the process determines whether the curtain 503 has reached its CLOSE limit as indicated at step 880. If the curtain 503 has not reached its CLOSE limit, then the process 800 returns to step 870, until the closed limit of the curtain 503 has been reached or control circuit 555 detects receipt of another command signal which would result in stopping of the curtain. If the CLOSE limit of the curtain 503 has been reached, then the process 800 continues to step 890, where the downward movement of the curtain 503 is stopped. In addition, after stopping the movement of the curtain 503, the process 800 returns to step 810, whereby the process awaits another activation or command signal from the transmitter 642.

Returning to step 850, if a LOCK command has been invoked, the process 800 moves to step 900. At step 900, the curtain 503 is moved downward, while somewhat simultaneously at step 910 the control circuit 555 monitors whether the current drawn by the motor 553 changes or if the count indicated that the curtain has reached the CHANNEL limit. And, more specifically, when the curtain has reached the first rest position shown in FIG. 43C. As noted previously, and as could be used throughout this operation, parameter values other than current sensing could be used. If the control circuit 555 determines that the electrical current consumed by the motor 553 is not noticeably changing, then the process returns to step 900. But if another command signal is received during movement of the curtain, the curtain is stopped. However, if the electrical current consumed by the motor 553 is noticeably changing, indicating that the CHANNEL limit of the curtain 503 has been reached or if the pulse count for the CHANNEL limit is reached, then the process 800 continues to step 920. At step 920 the control circuit 555 stops the downward movement of the curtain 503, and then proceeds to reverse direction, so as to move the curtain 503 in the upward direction, as indicated at step 930. Somewhat simultaneously with step 930, step 940 is performed whereby the control circuit 555 determines if an electrical current stall or noticeable change in current has occurred at the motor 553 or a pulse count limit has been reached. If no electrical current stall or noticeably change has occurred, or the pulse count limit has not been reached, then the process 800 returns to step 930, and the curtain 503 continues its upward movement. However, if a noticeable change in electrical current or a stall has occurred at the motor 553, then the process 800 continues to step 950, whereby the curtain 503 is identified as being in its locked position. Use of the previously stored pulse count may also indicate that the curtain has successfully reached the LOCK limit. Once, the curtain 503 is placed into its locked position, the movement of the curtain 503 is stopped as indicated at step 890, while the process 800 returns to step 810, whereby the process awaits another activation or command signal from the transmitter 642.

Returning to step 860, if an open command is received at the receiver 640 of the storm curtain assembly 500, the process continues to step 960. At step 960, the process 800 determines whether the curtain 503 is in a locked position. If the curtain 503 is not in a locked position, then the process continues to step 970, where the curtain 503 is moved in an upward direction. Somewhat simultaneously with the upward movement of the curtain 503, step 980 is performed. At step 980, the control circuit 555 determines whether an electrical current stall or noticeable change in current has occurred at the motor 553 or whether the appropriate count limit has been reached, indicating that the curtain 503 has reached its open limit. But if another command signal is received during movement of the curtain, the curtain is stopped. If an electrical current change or stall has not occurred at the motor 553 or the appropriate count limit has not bee reached, then the process 800 returns to step 970 where the curtain 503 continues to move upward. However, if an electrical current change or stall has occurred or a count limit has been reached, then the process 800 continues to step 990, where the movement of the curtain 503 is stopped, and the process returns to step 810 where the receiver 640 awaits another activation or command signal from the transmitter 642.

However, if at step 960, it is determined that the curtain 503 is in a locked position, then the control circuit 555 proceeds to move the curtain 503 in a downward direction, as indicated at step 1000. Somewhat simultaneously at step 1010, the control circuit 555 determines whether the motor 553 is drawing a changed amount of electrical current or a count limit has been reached indicating that the BOTTOM limit of the curtain 503 has been reached. And, more specifically, when the curtain has reached the second rest position shown in FIG. 43G. If the motor 553 is not drawing a changed amount of electrical current or a count limit has not been reached, then the process 800 returns to step 1000, and the curtain 503 continues its downward movement. However, if the control circuit 555 detects a variation in current drawn by the motor 553 or a count limit has been reached, then the process continues to step 1020 where the curtain 503 is placed into its unlocked position or BOTTOM limit position or more specifically, the second rest position. Once unlocked, the process 800 continues to step 1030 where the downward movement of the curtain 503 is stopped, and the motor 553 reverses direction so as to move the curtain 503 upward. Somewhat simultaneously with the upward movement of the curtain 503, step 980 is preformed, whereby the control circuit 555 determines whether the motor 553 has experienced a noticeable change in electrical current or a stall, or a count limit has been reached indicating that the open limit of the curtain 503 has been reached. If the motor 553 has not experienced a change in electrical current or a stall, or reached the predetermined count level, then the process continues to step 970, whereby the curtain 503 continues to be moved upward. However, if at step 980 the motor 553 experiences current change or stall, or reaches the predetermined count level, then the process 800 continues to step 990, where the curtain 503 is stopped at the Open limit, and the process terminates at step 810, where the receiver 640 awaits another activation or command signal to be sent from the transmitter 642.

The operational steps for an alternative method of controlling the movement of the curtain 503 are generally designated as the numeral 1100, as shown in FIG. 48 of the drawings. With regard to this embodiment, it should be appreciated that the storm curtain assembly 500 may be configured to utilize the stop 615, as discussed with respect to the embodiments shown in FIGS. 44 and 45. Additionally, before discussing the specific attributes of the operation of the instant embodiment of the storm curtain assembly 500, a brief summary of its operation will be presented. In one aspect, if the curtain 503 is fully opened, and an activation signal is sent by the transmitter 642 to the control circuit 555, then the curtain 503 is moved downward into a locked position. Alternatively, if the curtain 503 is in its locked position, and the activation signal is sent by the transmitter 642 to the control circuit 555, then the curtain 503 is unlocked, and moved into a fully opened position. In the event curtain 503 is positioned somewhere between the limit positions a LOAD MOVE variable will be set based upon the curtain's current position and the next expected direction of movement. The LOAD MOVE variable could be based upon the profiled pulse count value, the expected time to travel from the current position to a limit position, or a combination of both. Other parameters could also be used. The particular steps taken by the process 1100 will now be set forth below.

Initially, at step 1110, the user sends an activation or command signal via the remote transmitter 642, to the receiver 640 of the control circuit 555, so as to cause the curtain 503 to move. At step 1120, the process determines whether the curtain 503 is initially moving or not. If the curtain 503 is moving, then the process 1100 continues to step 1130, where the movement of the curtain 503 is stopped. Once the curtain 503 is stopped, the process returns to step 1110, where the control circuit 555 awaits for another activation or command signal to be sent from the transmitter 642. However, if the curtain 503 is not moving then the process 1100 continues to step 1140. At step 1140, the control circuit 555 determines whether the last movement of the curtain 503 was upward or downward. If the last movement of the curtain 503 was downward, then the process 1100 continues to step 1150 where a LOAD MOVE timeout variable is set. After the load move timeout variable is set, the process 1100 continues to step 1160 where the curtain 503 is moved upward. Somewhat simultaneously, at step 1170, the control circuit 555 determines whether the motor 553 has experienced a current stall or the LOAD MOVE time has elapsed. If the motor 553 has not experienced a current stall or the LOAD MOVE time has not elapsed, then the process 1100 returns to step 1160, as the curtain 503 continues to move upward. But if another command signal is received during movement of the curtain, the curtain is stopped. However, if an electrical current stall occurs at step 1170, then the process proceeds to step 1180 where the movement of the curtain 503 is stopped, so as to be in an unlocked position indicated at step 1190.

Returning to step 1140 of the process 1100, if the last move of the curtain 503 was in the upward direction, then the process 1100 continues to step 1200, where a load move timeout variable is set. Next, at step 1210 the curtain 503 is then moved downward. Somewhat simultaneously with the downward movement of the curtain 503, at step 1220, the control circuit 555 determines whether the motor 553 has drawn an increased amount of electrical current or has timed out in accordance with the set timeout variable as indicated at step 1220. In one aspect, the increased current may be due to the result of the tip 618 of the stop 615 engaging the upturned edge 619 of the curtain 503, if the stop 615 is utilized. If the control circuit 555 determines that the motor 553 has not drawn an increased amount of electrical current, then the process returns to step 1210 and the curtain 503 continues its downward movement. But if another command signal is received during movement of the curtain, the curtain is stopped. However, if the motor 553 draws an increased amount of electrical current, then the process 1100 continues to step 1230. At step 1230, the control circuit 555 stops the movement of the curtain 503, so as to place it in a locked position, as indicated at step 1240. Upon the completion of step 1240, the process 1100 returns to step 1110, where the receiver 642 awaits another activation or command signal to be sent from the transmitter 642.

In view of the foregoing, it should be evident that a curtain locking system made in accordance with any of the embodiments described herein substantially improves the art.

What is claimed is:

1. An assembly for covering a building opening, the assembly comprising
a shaft positioned at one end of the building opening,
a curtain carried by said shaft,
a locking mechanism at the opposed end of the building opening from said shaft that selectively holds said curtain in a locked position to cover the building opening,
an input for selectively rotating said shaft, and
a linking assembly adapted to transfer said input to said shaft to selectively rotate said shaft, wherein said linking assembly includes a failsafe portion designed to fail upon a predetermined impact force on said curtain.

2. The assembly of claim 1 wherein said input includes an electric motor.

3. The assembly of claim 1 wherein said input includes a pull cord.

4. The assembly of claim 1 further comprising a header positioned at the top of the building opening and a sill positioned at the bottom of the opening, said shaft being located inside said header and said locking mechanism being located inside said sill.

5. The assembly of claim 4 further comprising a pair of vertical channels and a locking bar, wherein said vertical channels extend between said header and said sill on opposed sides of the building opening and where said locking bar is secured to the bottom of said curtain and includes end portions that ride within said vertical channels.

6. The assembly of claim 5 wherein said locking mechanism includes a locking channel that receives said locking bar when said curtain is in said locked position.

7. The assembly of claim 6 wherein said locking channel is disposed at an angle relative to said vertical channels.

8. The assembly of claim 6 further comprising a derailleur adapted to selectively position said locking bar in said locking channel.

9. The assembly of claim 1 further comprising a header having an outer chamber and an inner chamber separated by a sealing wall, said shaft being positioned in said outer chamber and said input being positioned at least partially in said inner chamber.

10. The assembly of claim 1 wherein said linking assembly includes a drive gear, a driven gear and an intermediate gear, said driven gear being coupled to said shaft, said drive gear being adapted to be rotated by said input and said intermediate gear being positioned between said driven gear and said drive gear to transfer rotational force therebetween.

11. The assembly of claim 10 wherein said failsafe portion includes a pin, said intermediate gear being rotatably mounted to said pin, said pin being adapted to deform during said impact.

12. The assembly of claim 11 further including a toothed locking wall and wherein said intermediate gear includes a plurality of gear teeth on the outer surface thereof, and when said pin deforms said gear teeth engages said locking wall to prevent rotation of said intermediate gear.

13. The assembly of claim 1 wherein said linking assembly includes a drive gear and a driven gear, a sleeve and a spring, said driven gear being coupled to said shaft, said drive gear being positioned to intermesh with said driven gear, said sleeve being secured to said drive gear for rotation therewith, wherein said sleeve includes a key and said drive gear includes a slot that receives said key, said spring being connected to said sleeve and said drive gear, said input being coupled to said sleeve.

14. The assembly of claim 13 wherein said key shears upon said impact force and thereafter said drive gear is interconnected to said sleeve by said spring.

15. The assembly of claim 1 further including a stop, wherein said curtain is coupled to said shaft such that when said curtain is completely unrolled, said stop is adapted to engage said curtain and said shaft and prevent said curtain from counter-winding on said shaft.

16. An assembly for covering a building opening for preventing debris from entering a building interior, the assembly comprising
a header positioned at one end of the building opening, said header having an outer chamber and an inner chamber separated by a sealing wall, and said input being positioned at least partially in said inner chamber,
a shaft positioned in said outer chamber of said header,
a rotational input mechanism positioned in said inner chamber of said header,
wherein said sealing wall prevents moisture and debris from entering the building interior through said header.

17. The assembly of claim 16 wherein said input mechanism includes an electric motor.

18. The assembly of claim 16 wherein said input mechanism includes a pull cord.

19. The assembly of claim 16 further comprising a first cover and a second cover, wherein said first cover is removably secured to an exterior face of said header to substantially enclose said outer chamber and said second cover is removably secured to an interior face of said header to substantially enclose said inner chamber.

20. The assembly of claim 16 further comprising a pair of end supports positioned on opposed sides of said header and adapted to rotatably carry said shaft and span between said outer chamber and said inner chamber.

21. The assembly of claim 20 wherein each said end support includes a drive gear and a driven gear, said shaft being carried by said driven gear and said driven gear being adapted to be rotated by said input mechanism.

22. The assembly of claim 21 wherein said driven gear is positioned substantially within said outer chamber and said drive gear is positioned substantially within said inner chamber.

23. The assembly of claim 16 further comprising a linking assembly adapted to transfer a rotational input from said input mechanism to said shaft to selectively rotate said shaft, wherein said linking assembly includes a failsafe portion designed to fail upon a predetermined impact force on said curtain.

24. The assembly of claim 23 wherein said linking assembly includes a drive gear, a driven gear and an intermediate gear, said driven gear being coupled to said shaft, said drive gear being adapted to be rotated by said input and said intermediate gear being positioned between said driven gear and said drive gear to transfer rotational force therebetween.

25. The assembly of claim 24 wherein said failsafe portion includes a pin, said intermediate gear being rotatably mounted to said pin, said pin being adapted to deform during said impact.

26. The assembly of claim 25 further including a toothed locking wall and wherein said intermediate gear includes a plurality of gear teeth on the outer surface thereof, and when said pin deforms said gear teeth engages said locking wall to prevent rotation of said intermediate gear.

27. The assembly of claim 16 further comprising a sill positioned at the bottom of the opening and including a locking mechanism, and said header being positioned at the top of the opening.

28. The assembly of claim 27 further comprising a pair of vertical channels and a locking bar, wherein said vertical channels extend between said header and said sill on opposed sides of the building opening and where said locking bar is secured to the bottom of said curtain and includes end portions that ride within said vertical channels.

29. The assembly of claim 28 wherein said locking mechanism includes a locking channel that receives said locking bar when said curtain is in said locked position.

30. The assembly of claim 29 wherein said locking channel is disposed at an angle relative to said vertical channels.

31. The assembly of claim 30 further comprising a derailleur adapted to selectively position said locking bar in said locking channel.

32. An assembly for covering a building opening, the assembly comprising
a shaft positioned at one end of the opening,
a cover carried by said shaft,
a stop positioned proximate to said shaft, wherein said curtain is coupled to said shaft such that when said curtain is completely unrolled, said stop is adapted to engage said curtain and said shaft and prevent said curtain from counter-winding on said shaft.

33. The assembly of claim 32 wherein said stop is in the form of elongated plate and includes a cylindrical portion pivotally received in a catch.

34. The assembly of claim 32 wherein said curtain is secured to said shaft so that when said curtain begins counter-winding, an upturned edge of said curtain is formed, said stop engaging said upturned edge to prevent further rotation of said shaft in a counter-winding direction.

35. An assembly for covering a building opening for preventing debris from entering a building interior, the assembly comprising
a header positioned at one end of the building opening, said header having an outer chamber and an inner chamber separated by a sealing wall,
a shaft positioned in said outer chamber of said header,
a curtain carried by said shaft,
a locking mechanism at the opposed end of the building opening from said shaft that selectively holds said curtain in a locked position to cover the building opening,
an input mechanism positioned at least partially in said inner chamber of said header for selectively rotating said shaft, and
a linking assembly adapted to transfer a rotational input from said input mechanism to said shaft to selectively rotate said shaft,
wherein said linking assembly includes a failsafe portion designed to fail upon a predetermined impact force on said curtain and said sealing wall prevents moisture and debris contacting said input mechanism.

36. A method of profiling movement of a movable barrier comprising
providing a motor assembly with a control circuit to control movement of a barrier,
initiating a profiling mode at said control circuit,
moving said barrier to a first position,
setting a first limit,
moving the barrier in an opposite direction toward a second position until a predetermined parameter is detected by the control circuit,
setting a second limit,
moving the barrier in another direction to a third position until said predetermined parameter is detected by said control circuit, and
setting a third limit that is between the first limit and the second limit.

37. The method of claim 36, further comprising
associating the limits with values from at least one sensor connected to the control circuit, and
maintaining a reference position value of the barrier in the control circuit as determined by said at least one sensor.

38. The method of claim 37, further comprising
associating the positions with values from the at least one sensor.

39. A method of operating a barrier operator comprising
moving a barrier between paths defined by an open limit position, a close limit position, and a lock limit position, wherein the lock limit position is not in the path defined between the open and close limit positions.

40. The method of claim 39 further comprising
providing a motor assembly with a control circuit to control the movement of the barrier,
initiating a close command at the control circuit,
moving the barrier until a close limit position is reached, and
stopping the movement of the barrier at the close limit position.

41. The method of claim 40, wherein prior to said moving step, said process further comprises
determining if the barrier is moving, and
stopping the movement of the barrier if the barrier is moving.

42. The method of claim 39 comprising
providing a motor assembly with a control circuit to control the movement of the barrier,
initiating a lock command at the control circuit,
moving the barrier toward one of the open limit position and the close limit position until a predetermined parameter is detected by the control circuit,
stopping the movement of the barrier,
moving the barrier to the lock limit position until the predetermined parameter is detected by the control circuit, and
stopping the movement of the barrier at the lock limit position.

43. The method of claim 42, wherein said first stopping step stops the barrier at a resting position that extends past the close limit position.

44. The method of claim 42, wherein prior to said first moving step, the method comprises
determining if the barrier is moving, and
stopping the movement of the barrier if the barrier is moving.

45. The method of claim 39, further comprising
providing a motor assembly with a control circuit to control the movement of the barrier,
initiating an open command at the control circuit,
moving the barrier toward the close limit position until a predetermined parameter value is detected by the control circuit,
stopping the movement of the barrier,
moving the barrier toward the open limit position until a predetermined parameter value is detected by the control circuit, and
stopping the movement of the barrier at the open limit position.

46. The method of claim 45, wherein said first stopping step stops the barrier at a resting position that extends below said lock limit position.

47. The method of claim 45, wherein prior to said first moving step, the method comprises
determining if the barrier is moving, and
stopping the movement of the barrier if the barrier is moving.

48. The method of claim 39, further comprising
providing a motor assembly with a control circuit to control the movement of the barrier, wherein the barrier is a position other than at the lock limit position,
initiating an open command at the control circuit,
moving the barrier toward the open limit position until the predetermined parameter value is detected by the control circuit, and
stopping the movement of the barrier at the open limit position.

49. The method of claim 48, wherein prior to said moving step, the method comprises
determining if the barrier is moving, and
stopping the movement of the barrier if the barrier is moving.

50. The method of claim 39, further comprising
providing a motor assembly with a control circuit to control the movement of the barrier,
loading a first move timeout variable at the control circuit if the last movement of the barrier was toward the open limit position,
moving the barrier toward the close limit position until the first move time out variable has expired, and
stopping the movement of the barrier at the close limit position, where the barrier is locked.

51. The method of claim 39, further comprising
providing a motor assembly with a control circuit to control the movement of the barrier,
moving the barrier toward the close limit position until a predetermined parameter value is detected by the control circuit, if the last movement of the barrier was toward the open limit position, and
stopping the movement of the barrier at the close limit position, where the barrier is locked.

52. The method of claim 51, wherein the predetermined parameter value is an electrical current stall caused by an upturned edge of the barrier contacting an associated stop maintained by the motor assembly.

53. The method of claim 39, further comprising
loading a move timeout variable if the last movement of the barrier was not toward the open limit position,
moving the barrier toward the open limit position until the timeout variable has expired, and
stopping the movement of the barrier whereby the barrier is unlocked.

54. The method of claim 39, further comprising
moving the barrier toward the open limit position until a predetermined parameter value is detected by the control circuit, if the last movement of the barrier was toward the close limit position, and
stopping the movement of the barrier, whereby the barrier is unlocked.

55. The method of claim 54, wherein the predetermined parameter value is an electrical current stall caused by an upturned edge of the barrier contacting an associated stop maintained by the motor assembly.

56. The method of claim 39, further comprising
providing a motor assembly with a control circuit to control the movement of the barrier,
actuating the control circuit so as to move the barrier,
determining if the barrier is at the lock limit position, so as to be locked,
loading a lock time out variable if the barrier is at the lock limit position,
moving the barrier toward the close limit position until the timeout variable has expired, and
stopping the movement of the barrier, whereby the barrier is unlocked.

57. The method of claim 56, further comprising
loading a move timeout variable,
moving the barrier toward the open limit position until the move timeout variable has expired, and
stopping the movement of the barrier, whereby the barrier is opened.

58. The method of claim 39, further comprising
providing a motor assembly with a control circuit to control the movement of the barrier,
determining if the barrier is at the lock limit position, so as to be locked,
loading a move timeout variable if the barrier is not at the lock limit position,
moving the barrier toward the close limit position until the timeout variable has expired,
stopping the movement of the barrier,
loading a lock timeout variable, and
moving the barrier toward the lock limit position until the lock timeout variable has expired, whereby the barrier is locked at the lock limit position.
